(19) United States
(12) Patent Application Publication
(10) Pub. No.: US 2023/0281960 A1
(43) Pub. Date: Sep. 7, 2023

(54) METHOD, APPARATUS AND RECORDING MEDIUM FOR ENCODING/DECODING IMAGE USING FEATURE MAP OF ARTIFICIAL NEURAL NETWORK

(71) Applicants: Electronics and Telecommunications Research Institute, Daejeon (KR); UNIVERSITY-INDUSTRY COOPERATION GROUP OF KYUNG HEE UNIVERSITY, Yongin-si Gyeonggi-do (KR)

(72) Inventors: Youn-Hee KIM, Daejeon (KR); Se-Yoon JEONG, Daejeon (KR); Ji-Hoon DO, Daejeon (KR); Joo-Young LEE, Daejeon (KR); Hyoung-Jin KWON, Daejeon (KR); Dong-Hyun KIM, Daejeon (KR); Jong-Ho KIM, Daejeon (KR); Sung-Chang LIM, Daejeon (KR); Woong LIM, Daejeon (KR); Jin-Soo CHOI, Daejeon (KR); Tae-Jin LEE, Daejeon (KR); Hui-Yong KIM, Daejeon (KR); Chang-Kyun CHOI, Seoul (KR); Jung-Heum KANG, Seongnam-si Gyeonggi-do (KR); Sung-Ho BAE, Yongin-si Gyeonggi-do (KR); Hye-Won JEONG, Anyang-si Gyeonggi-do (KR)

(73) Assignees: Electronics and Telecommunications Research Institute, Daejeon (KR); UNIVERSITY-INDUSTRY COOPERATION GROUP OF KYUNG HEE UNIVERSITY, Yongin-si Gyeonggi-do (KR)

(21) Appl. No.: 18/112,403

(22) Filed: Feb. 21, 2023

(30) Foreign Application Priority Data
Feb. 21, 2022 (KR) 10-2022-0022471
May 11, 2022 (KR) 10-2022-0057853
Oct. 6, 2022 (KR) 10-2022-0127891
Jan. 27, 2023 (KR) 10-2023-0010968

(51) Int. Cl. G06V 10/771; G06T 3/40; G06T 9/00; G06V 10/28; G06V 10/82

(52) U.S. Cl. CPC G06V 10/771; G06T 3/4053; G06T 9/00; G06V 10/28; G06V 10/82

(57) ABSTRACT

Disclosed herein is an encoding method. The encoding method includes extracting a feature map from an input image, determining an encoding feature map based on the extracted feature map, generating a converted feature map by performing conversion on the encoding feature map, and performing encoding on the converted feature map.

### CROSS REFERENCE TO RELATED APPLICATIONS

This application claims priority to Korean Patent Applications No. 10-2022-0022471, filed Feb. 21, 2022, No. 10-2022-0057853, filed May 11, 2022, No. 10-2022-0127891, filed Oct. 6, 2022, and No. 10-2023-0010968, filed Jan. 27, 2023, in the Korean Intellectual Property Office, which are hereby incorporated by reference in their entireties into this application.

### BACKGROUND OF THE INVENTION

### 1. Technical Field

The present disclosure relates to a method, apparatus, and recording medium for image encoding/decoding. More particularly, the present disclosure provides a method, apparatus, and recording medium for image encoding/decoding using a feature map of an artificial neural network.

### 2. Description of the Related Art

As tasks using machine learning are widely used in various devices including mobile devices as well as large servers, the number of cases where a means of extracting a feature map and a means of performing a task are separately located in different devices, rather than being located in a single device, is increasing.

When the means of extracting a feature map and the means of performing a task are separate from each other, as described above, a feature map extracted by the extraction means has to be transferred to the means of performing a task. However, because the data amount of the feature map is very large, a feature-map-encoding method for reducing the data amount of the feature map while minimizing degradation in task performance is required.

Also, when the resolution of the feature map is decreased by selecting an encoding feature map having lower resolution than the original feature map, the detection rate of small objects may decrease, so it is necessary to compensate for this.

### SUMMARY OF THE INVENTION

An embodiment may provide an apparatus, method, and recording medium for reducing degradation in performance of a task while reducing the amount of compressed bits of a feature map by providing a method for converting the resolution of the feature map extracted through an artificial neural network and a method for encoding the feature map.

An embodiment may provide an apparatus, method, and recording medium for improving feature map encoding performance by aligning the size of a feature map channel with a block size of a means of encoding a feature map.

An embodiment may provide an apparatus, method, and recording medium that use a super-resolution technique as a method for converting the resolution of a feature map.

An embodiment may provide an apparatus, method, and recording medium that use a result generated by applying compression and reconstruction to a feature map as training data.

An embodiment may provide an apparatus, method, and recording medium for improving resolution while reducing compression artifacts of a feature map by learning super-resolution using training data.

An embodiment may provide an apparatus, method, and recording medium for decreasing the resolution of a feature map channel and applying super-resolution to a reconstructed image, which is generated by compressing and adjusting the feature map adjusted to have lower resolution.

An embodiment may provide an apparatus, method, and recording medium for improving encoding performance by performing compression and reconstruction using some of multiple feature maps.

An embodiment may provide an apparatus, method, and recording medium capable of reconstructing multiple feature maps by compressing and transmitting feature map information including a feature map reconstruction mode.

In order to accomplish the above objects, an encoding method according to an embodiment of the present disclosure includes extracting a feature map from an input image, determining an encoding feature map based on the extracted feature map, generating a converted feature map by performing conversion on the encoding feature map, and performing encoding on the converted feature map.

Here, the encoding feature map may correspond to at least any one of multi-layer feature maps extracted from the input image.

Here, generating the converted feature map may include adjusting the resolution of the encoding feature map.

Here, the encoding feature map may correspond to any one of a feature map, the layer and resolution of which differ from the layer and resolution of a feature map to be reconstructed, a feature map, the layer of which is identical to the layer of the feature map to be reconstructed, and, the resolution of which differs from the resolution of the feature map to be reconstructed, and a feature map, the layer and resolution of which are identical to the layer and resolution of the feature map to be reconstructed.

Here, performing the encoding may comprise performing encoding on the converted feature map and metadata on the converted feature map, and the metadata may include information about the feature map to be reconstructed based on the encoding feature map.

Here, when the resolution of the encoding feature map is adjusted, the metadata may further include information about the size of the encoding feature map.

Here, determining the encoding feature map may comprise determining the encoding feature map differently depending on a quantization parameter of the extracted feature map.

Here, the metadata may include information about a feature map reconstruction mode, and the feature map reconstruction mode may correspond to any one of an inter-layer resolution adjustment mode, an intra-layer resolution adjustment mode, and a resolution non-adjustment mode.

Also, in order to accomplish the above objects, a decoding method according to an embodiment of the present disclosure includes reconstructing a converted feature map by performing decoding on information about an encoded feature map; and generating a reconstructed feature map by performing inverse conversion on the reconstructed converted feature map.

Here, the encoded feature map may correspond to any one of multi-layer feature maps extracted from an input image or a feature map, the resolution of which is adjusted.

Here, generating the reconstructed feature map may comprise adjusting the resolution of the reconstructed feature map.

Here, the encoded feature map may correspond to any one of a feature map, the layer and resolution of which differ from the layer and resolution of a feature map to be reconstructed, a feature map, the layer of which is identical to the layer of the feature map to be reconstructed, and, the resolution of which differs from the resolution of the feature map to be reconstructed, and a feature map, the layer and resolution of which are identical to the layer and resolution of the feature map to be reconstructed.

Here, reconstructing the converted feature map may comprise performing decoding on the encoded feature map and metadata on the encoded feature map, and the metadata may include information about the feature map to be reconstructed based on the encoded feature map.

Here, when the resolution of the encoded feature map is adjusted, the metadata may further include information about the size of the encoded feature map.

Here, the metadata may include information about a feature map reconstruction mode, and the feature map reconstruction mode may correspond to any one of an inter-layer resolution adjustment mode, an intra-layer resolution adjustment mode, and a resolution non-adjustment mode.

Also, in order to accomplish the above objects, a computer-readable recording medium according to an embodiment of the present disclosure stores a bitstream for image decoding. The bitstream includes encoded feature map information and metadata, and a hierarchical feature map is decoded using the encoded feature map information and metadata.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is an example of a result of a machine task that detects and classifies objects using a Fast, Region-based, Convolutional Neural Network (Fast R-CNN), which is one of artificial neural networks;

FIG. 2 illustrates the structure of a mask R-CNN according to an example;

FIGS. 3 to 5 illustrate a single-layer feature map and a multi-layer feature map;

FIG. 6 illustrates an original feature map according to an example;

FIG. 7 illustrates a p2 feature map according to an example;

FIG. 8 illustrates a p3 feature map according to an example;

FIG. 9 illustrates a p4 feature map according to an example;

FIG. 10 illustrates a p5 feature map according to an example;

FIG. 11 illustrates a p6 feature map according to an example;

FIG. 12 illustrates multi-task model collaboration intelligence according to an example;

FIG. 13 is a structural diagram of an encoding apparatus according to an embodiment;

FIG. 14 is a structural diagram of a decoding apparatus according to an embodiment;

FIG. 15 is a structural diagram of a feature map converter according to an example;

FIG. 16 is a structural diagram of an inverse feature-map converter according to an example;

FIG. 17A illustrates an example of performing feature map encoding based on an existing image encoding apparatus and decoding apparatus, such as HEVC and VVC;

FIG. 17B illustrates an example of using an artificial neural network for feature map encoding;

FIG. 18A and FIG. 18B illustrate feature map channel size adjustment to which a super-resolution technique is applied;

FIG. 19 illustrates a method for adjusting resolution of a feature map within a layer;

FIG. 20 illustrates a method for adjusting resolution of a feature map between layers;

FIG. 21 is a flowchart of a method for encoding a feature map according to an embodiment;

FIG. 22 is a flowchart of a method for decoding a feature map according to an embodiment;

FIG. 23 illustrates the size of a coding block according to an example;

FIG. 24 illustrates a channel of a feature map before the size thereof is adjusted according to an example;

FIG. 25 illustrates a channel of a feature map after the size thereof is adjusted according to an example;

FIG. 26 illustrates the relationship between the location of information of a channel of a feature map before size adjustment and the location of the information of the channel of the feature map after size adjustment according to an example;

FIG. 27 illustrates the relationship between the location of information of a channel of a feature map before size adjustment and the location of the information of the channel of the feature map after size adjustment according to another example;

FIG. 28 illustrates the relationship between the location of information of a channel of a feature map before size adjustment and the location of the information of the channel of the feature map after size adjustment according to a further example;

FIG. 29A illustrates adjustment of sizes of feature map channels according to an embodiment;

FIG. 29B illustrates adjustment of sizes of feature map channels in consideration of super-resolution according to an example;

FIG. 30 is a flowchart illustrating an encoding method according to an embodiment of the present disclosure;

FIG. 31 is a flowchart illustrating a decoding method according to an embodiment of the present disclosure;

FIG. 32 is a structural diagram of an encoding apparatus according to an embodiment;

FIG. 33 is a structural diagram of a decoding apparatus according to an embodiment;

FIG. 34 and FIG. 35 are examples of determining an encoding feature map and the feature map to be reconstructed;

FIG. 36 illustrates a method for determining a different encoding feature map for each layer;

FIG. 37 is a table illustrating that a different encoding feature map and a different feature map reconstruction mode are determined for each layer;

FIG. 38 illustrates a method for determining a different encoding feature map for a feature map of a different layer extracted from a different image;

FIG. 39 is a table illustrating that an encoding feature map and a feature map reconstruction mode are determined for a feature map of a different layer extracted from a different image;

FIG. 40 illustrates a method for determining an encoding feature map when the same image is encoded using different quantization parameters;

FIG. 41 is a table illustrating that an encoding feature map and a feature map reconstruction mode are determined when the same image is encoded using different quantization parameters;

FIG. 42 illustrates a method for determining a quantization parameter by an encoding feature map determination unit;

FIG. 43 is a table illustrating that an encoding feature map and a feature map reconstruction mode are determined when an encoding feature map determination unit determines a quantization parameter;

FIG. 44 illustrates that an encoding feature map determination unit determines a resolution adjustment method;

FIG. 45 is a table illustrating that an encoding feature map and a feature map reconstruction mode are determined when an encoding feature map determination unit determines a resolution adjustment method;

FIG. 46 illustrates a method for determining a quantization parameter by an encoding feature map determination unit;

FIG. 47 is a table illustrating that an encoding feature map and a feature map reconstruction mode are determined when an encoding feature map determination unit determines a quantization parameter;

FIG. 48 illustrates the case in which feature maps of multiple layers are input to an encoding feature map determination unit;

FIG. 49 illustrates the case in which a single feature map is input to an encoding feature map determination unit;

FIG. 50 is a table illustrating an encoding feature map according to a method for reconstructing the feature map of layer m;

FIG. 51 and FIG. 52 are examples of inter-layer resolution adjustment;

FIG. 53 is an example of intra-layer resolution adjustment;

FIG. 54 is an example in which resolution adjustment is not applied;

FIG. 55 illustrates the configuration of a feature map according to an example;

FIG. 56 illustrates a spatially arranged feature map according to an example;

FIG. 57 illustrates a temporally arranged feature map according to an example;

FIG. 58 illustrates a feature map arranged in a spatiotemporal manner according to an example;

FIG. 59 illustrates information required for deriving encoding feature map resolution adjustment information;

FIG. 60 illustrates information required for deriving a feature map reconstruction mode; and

FIG. 61 illustrates an encoding and decoding method according to an embodiment of the present disclosure.

### DESCRIPTION OF THE PREFERRED EMBODIMENTS

The present disclosure may be variously changed, and may have various embodiments, and specific embodiments will be described in detail below with reference to the attached drawings. However, it should be understood that those embodiments are not intended to limit the present disclosure to specific disclosure forms, and that they include all changes, equivalents or modifications included in the spirit and scope of the present disclosure.

Detailed descriptions of the following exemplary embodiments will be made with reference to the attached drawings illustrating specific embodiments as examples. These embodiments are described in detail so that those skilled in the art can easily practice the embodiments. It should be noted that the various embodiments are different from each other, but do not need to be mutually exclusive of each other. For example, specific shapes, structures, and characteristics described here may be implemented as other embodiments without departing from the spirit and scope of the present disclosure in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of elements in the drawings may be exaggerated to make the description clear.

In the present disclosure, terms such as “first” and “second” may be used to describe various components, but the components are not restricted by the terms. The terms are used only to distinguish one component from another component. For example, a first component may be named a second component without departing from the scope of the present disclosure. Likewise, a second component may be named a first component. The terms “and/or” may include combinations of a plurality of related described items or any of a plurality of related described items.

It will be understood that when a component is referred to as being “connected” or “coupled” to another component, the component may be directly connected or coupled to the other component, or intervening components may be present between the two components. In contrast, it will be understood that when a component is referred to as being “directly connected or coupled”, no intervening components are present between the two components.

Also, components described in the embodiments are independently shown in order to indicate different characteristic functions, but this does not mean that each of the components is formed of a separate piece of hardware or software. That is, the components are arranged and included separately for convenience of description. For example, at least two of the components may be integrated into a single component. Conversely, one component may be divided into multiple components so as to perform functions. An embodiment into which the components are integrated or an embodiment in which some components are separated is included in the scope of the present disclosure as long as it does not depart from the essence of the present disclosure.

The terms used in embodiments are merely used to describe specific embodiments and are not intended to limit the present disclosure. A singular expression includes a plural expression unless a description to the contrary is specifically pointed out in context. In embodiments, it should be understood that the terms such as “include” or “have” are merely intended to indicate that features, numbers, steps, operations, components, parts, or combinations thereof in the specification are present, and are not intended to exclude the possibility that one or more other features, numbers, steps, operations, components, parts, or combinations thereof will be present or added. That is, it will be understood that the term “comprising”, when used herein, does not preclude the presence or addition of other elements, but an additional element may also be included in the embodiments or the scope of the technical idea of the present disclosure.

In embodiments, the term “at least one” may mean one of numbers of 1 or more, such as 1, 2, 3, and 4. In the embodiments, the term “a plurality of” may mean one of numbers of 2 or more, such as 2, 3, or 4.

Some components of embodiments may not be essential components for performing the substantial functions in the present disclosure, or may be optional components merely for improving performance. Embodiments may be implemented by including only components essential to the embodiments, excluding components used merely to improve performance, and structures including only essential components and excluding optional components used merely to improve performance also fall within the scope of the embodiments.

Hereinafter, embodiments of the present disclosure will be described in detail with reference to the accompanying drawings such that those having ordinary knowledge in the technical field to which the present disclosure pertains can easily practice the embodiments. In the following description of the embodiments, detailed descriptions of known functions or configurations which are deemed to obscure the gist of the present specification will be omitted, and the same reference numerals are used to designate the same components throughout the drawings, and repeated descriptions of the same components will be omitted.

Hereinafter, an image may mean a single picture constituting video, or may indicate the video itself. For example, “encoding and/or decoding of an image” may mean “encoding and/or decoding of video”, and may also mean “encoding and/or decoding of any one of images constituting the video”.

Hereinafter, the terms “video” and “motion picture(s)” may be used to have the same meaning, and may be used interchangeably with each other.

Hereinafter, a target image may be an encoding target image, which is the target to be encoded, and/or a decoding target image, which is the target to be decoded. Further, the target image may be an input image that is input to an encoding apparatus or an input image that is input to a decoding apparatus. Also, the target image may be a current image that is the target to be currently encoded and/or decoded. For example, the terms “target image” and “current image” may be used to have the same meaning, and may be used interchangeably with each other.

Hereinafter, the terms “image”, “picture”, “frame”, and “screen” may be used to have the same meaning, and may be used interchangeably with each other.

Hereinafter, a target block may be an encoding target block, which is the target to be encoded, and/or a decoding target block, which is the target to be decoded. Further, the target block may be a current block that is the target to be currently encoded and/or decoded. For example, the terms “target block” and “current block” may be used to have the same meaning, and may be used interchangeably with each other. The current block may mean an encoding target block, which is the target to be encoded at the time of encoding, and/or a decoding target block, which is the target to be decoded at the time of decoding.

Hereinafter, the terms “block” and “unit” may be used to have the same meaning, and may be used interchangeably with each other. Alternatively, “block” may denote a specific unit.

Hereinafter, the terms “region” and “segment” may be used interchangeably with each other.

In the following embodiments, specific information, data, a flag, an index, an element, and an attribute may have their respective values. A value of “0” corresponding to each of the information, data, flag, index, element, and attribute may indicate false, logical false, or a first predefined value. In other words, the value of “0”, false, logical false, and a first predefined value may be used interchangeably with each other. A value of “1” corresponding to each of the information, data, flag, index, element, and attribute may indicate true, logical true, or a second predefined value. In other words, the value of “1”, true, logical true, and a second predefined value may be used interchangeably with each other.

When a variable such as i or j is used to indicate a row, a column, or an index, the value of i may be an integer equal to or greater than 0 or an integer equal to or greater than 1. In other words, in the embodiments, each of a row, a column, and an index may be counted from 0 or may be counted from 1.

In embodiments, the term “one or more” or the term “at least one” may mean the term “a plurality of”. The term “one or more” or “at least one” may be replaced with the term “a plurality of”.

### Artificial Neural Network and Machine Task

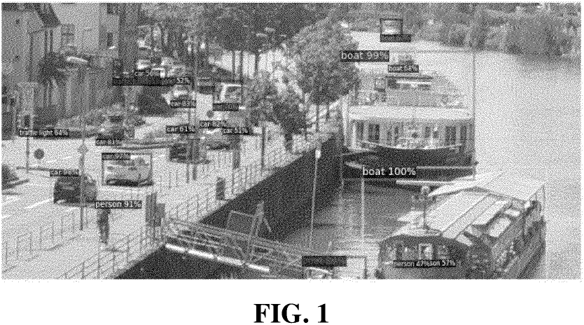

FIG. 1 is an example of a result of a machine task that detects and classifies objects using a Fast, Region-based, Convolutional Neural Network (Fast R-CNN), which is one of artificial neural networks.

Artificial Neural Networks (ANNs) are increasingly used for various machine vision tasks, such as object classification, object recognition, object detection, object segmentation, object tracking, and the like, or machine tasks, such as various image-processing tasks including super-resolution, frame-interpolation, and the like.

### Means of Extracting Feature Map and Means of Performing Task

An artificial neural network model for performing a machine task may be generally configured with a feature map extraction means for extracting features from input data or an input image and a task-performing means for actually performing a specific machine task based on the extracted features.

Here, when the input is in the form of an image, the extracted feature may be generally called a feature map.

In embodiments, a description is made using the expression “feature map”, but even when a feature is in a form other than a map, the embodiments may be applied in the same manner. Also, the term “feature map” or “feature map information” may be replaced with the term “feature”.

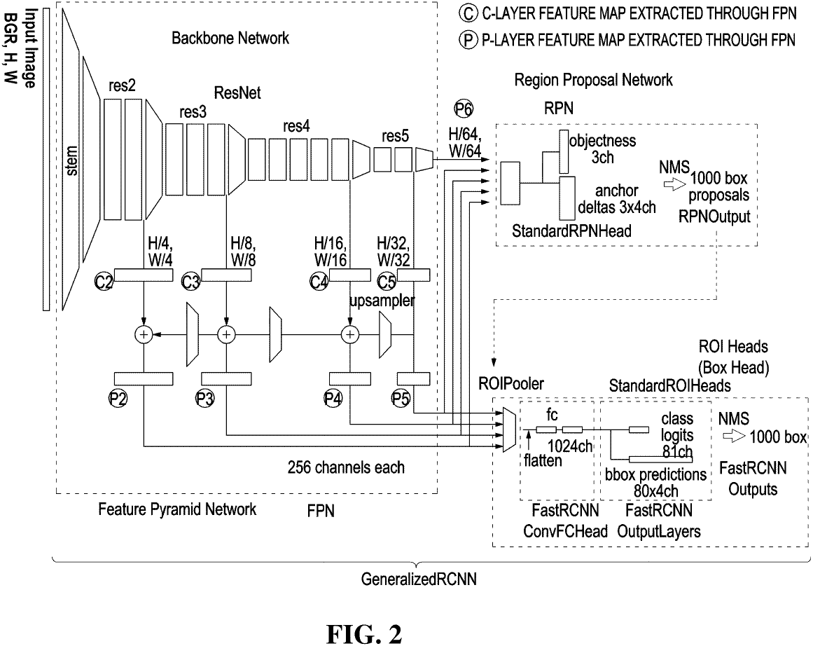

FIG. 2 illustrates the structure of a mask R-CNN according to an example.

A mask R-CNN may be an artificial neural network model used for object segmentation.

In this structure, a Feature Pyramid Network (FPN) may be used as a means of extracting a feature map, and a Region Proposal Network (RPN) and Region Of Interest Heads (ROI Heads) may be used as a means of performing a task.

The Feature Pyramid Network (FPN) is an example of extracting a multi-layer feature map, which includes a C-layer feature map and a P-layer feature map. All of the C-layer feature map and the P-layer feature map are multi-layer feature maps.

A multi-layer feature map of the disclosure will be described below using the P-layer feature map in FIG. 2, and a single-layer feature map of the disclosure will be described below using one layer of the P-layer feature map. However, the present disclosure may also be applied in the same manner to a single-layer feature map or a multi-layer feature map in a form other than that illustrated in FIG. 2.

### Feature Map

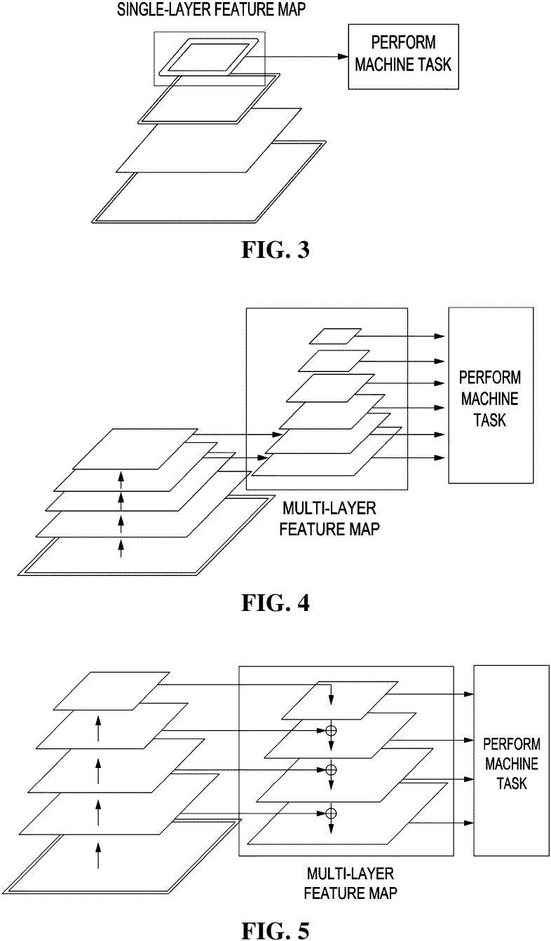

FIGS. 3 to 5 illustrate a single-layer feature map and a multi-layer feature map.

FIG. 3 illustrates a single-layer feature map, and FIG. 4 and FIG. 5 illustrate multi-layer feature maps.

When the feature map of an artificial neural network is configured with only a single layer, it is referred to as a single-layer feature map, whereas when it is configured with multiple layers, it is referred to as a multi-layer feature map.

Depending on the type of artificial neural network or the type of machine task, a single-layer feature map or a multi-layer feature map may be used. The present disclosure may be applied both to a single-layer feature map and to a multi-layer feature map.

The single-layer feature map is a feature map configured with only a single layer, and when a machine task is performed, the task may be performed using only the single layer. Also, even when a machine task is performed using only one of the layers of a multi-layer feature map, it is the case of using a single-layer feature map.

The multi-layer feature map may have a pyramid structure in which feature maps having different resolution sizes constitute multiple layers. The higher the layer to which a feature map belongs, the lower the resolution of the feature map, but the lower the layer to which the feature map belongs, the higher the resolution of the feature map.

Generally, a feature map at a high layer is advantageous to detection of large objects, and a feature map at a low layer is advantageous to detection of small objects. Feature maps at the same layer may have the same resolution. Mobile devices and the like may perform a machine task using feature maps of multiple layers.

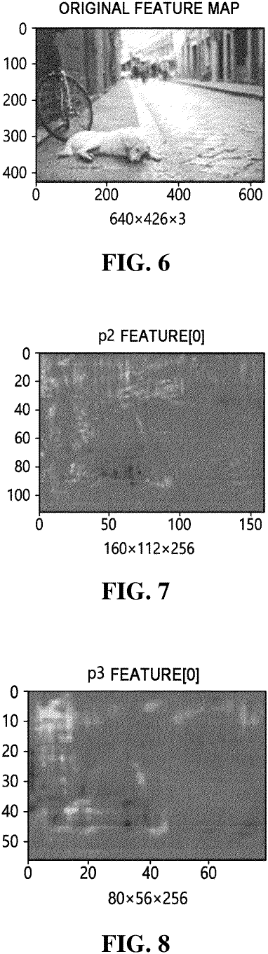

FIG. 6 illustrates an original feature map according to an example.

FIG. 7 illustrates a p2 feature map according to an example.

FIG. 8 illustrates a p3 feature map according to an example.

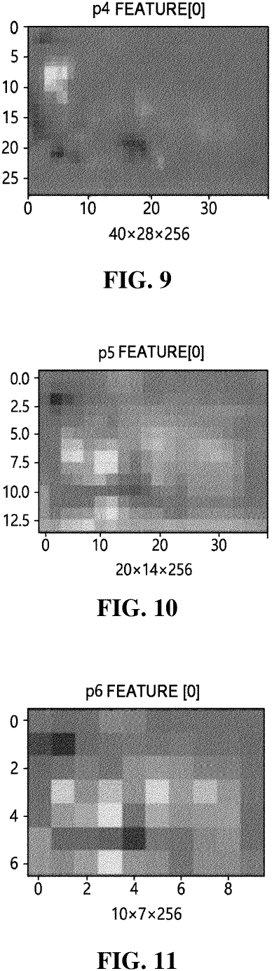

FIG. 9 illustrates a p4 feature map according to an example.

FIG. 10 illustrates a p5 feature map according to an example.

FIG. 11 illustrates a p6 feature map according to an example.

When the input is an image, the form of a feature map may be represented as a 2-dimensional array of width × height. Because a feature map of a layer may be generally configured with multiple channels, the feature map of each layer may be represented as a 3-dimensional array having a size of width × height × the number of channels.

That is, when a feature map of layer k is Fₖ, Fₖ may be represented using a 3-dimensional array Fₖ[x][y][c] that is formed of extracted feature values. Here, x and y may indicate the horizontal position and vertical position of a feature value, respectively. c may indicate a channel index.

FIGS. 3 to 8 illustrate feature maps extracted through the FPN of the mask R-CNN, which is described above with reference to FIG. 2.

In the FPN, a feature map of each layer may be configured with 256 channels. In FIGS. 3 to 8, only a feature map corresponding to the first channel, among feature maps of respective layers, is exemplarily illustrated.

Here, the deeper the layer in the FPN, the smaller the width and height of the feature map, compared to the width and height of the input image (that is, the original image).

### Multi-Task Model Collaboration Intelligence

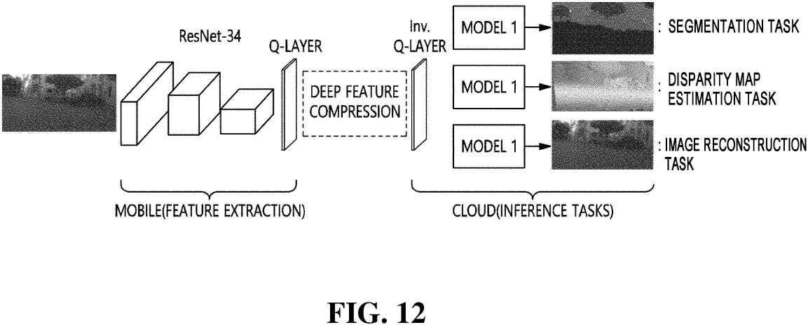

FIG. 12 illustrates multi-task model collaboration intelligence according to an example.

As a machine task is widely used in various devices including mobile devices as well as large servers, the number of cases in which a means of extracting a feature map and a means of performing a task are located in different devices, rather than in the same device, is increasing.

FIG. 12 shows the case in which, although the means of extracting a feature map is located in a mobile device, the means of performing a specific task, such as object segmentation, disparity map estimation, image reconstruction, or the like, is located in a cloud server.

In this case, the feature map extracted in the mobile device may be transferred to the server, and the result of performing the task in the server may be transferred back to the mobile device.

When the means of extracting a feature map is separate from the means of performing a task, as in the above example, it is necessary to transfer the extracted feature map to the means of performing a task. Further, a feature map encoding method for minimizing the data amount of the feature map to be transferred or stored while minimizing degradation in task performance may be required.

In another example, even when the means of extracting a feature map and the means of performing a task are located in the same device, the extracted feature map may be stored in a storage device, after which the stored feature map may be used by the means of performing a task. In this case, the above feature map encoding method may also be required.

In embodiments, such a method and apparatus for feature map encoding may be proposed.

In embodiments, the means may indicate a specific apparatus.

### Structures of Apparatuses of Embodiments

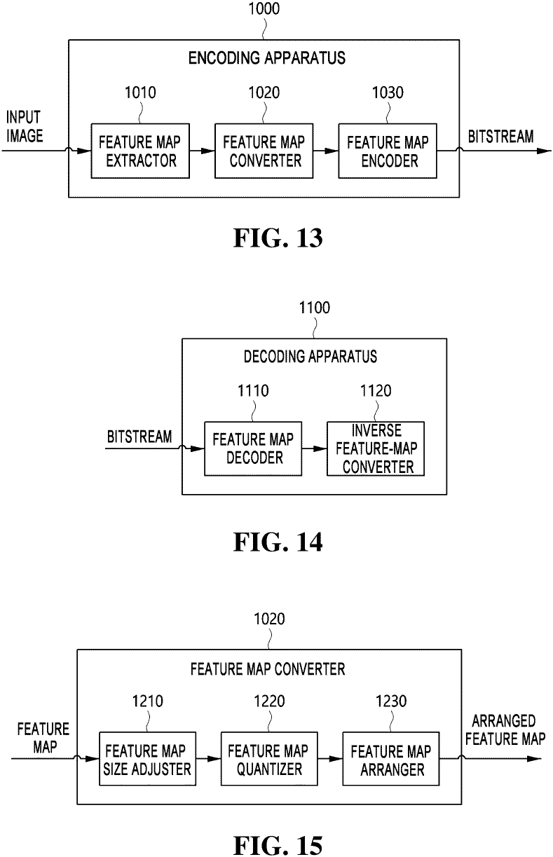

FIG. 13 is a structural diagram of an encoding apparatus according to an embodiment.

The encoding apparatus 1000 may include a feature map extractor 1010, a feature map converter 1020, and a feature map encoder 1030.

The feature map extractor 1010 may extract a feature map from an input image.

The feature map converter 1020 performs conversion on the extracted feature map, thereby generating a converted feature map.

The conversion may include quantization, padding, size adjustment, arrangement, and the like of the feature map.

The feature map may be converted into a format suitable for encoding by the feature map converter 1020.

The feature map encoder 1030 may perform encoding on the converted feature map.

The feature map encoder 1030 performs encoding on the converted feature map, thereby generating information about the (encoded) feature map.

The encoding may include compression.

The information about the (encoded) feature map may be transmitted to a decoding apparatus 1100 through a bitstream or the like, and may be stored in a computer-readable recording medium, or the like.

FIG. 14 is a structural diagram of a decoding apparatus according to an embodiment.

The decoding apparatus 1100 may include a feature map decoder 1110 and an inverse feature-map converter 1120.

The feature map decoder 1110 performs decoding on the information about the (encoded) feature map, which is stored in a bitstream or a computer-readable recording medium, thereby reconstructing the converted feature map.

The inverse feature-map converter 1120 performs inverse conversion on the (reconstructed) converted feature map, thereby generating a (reconstructed) feature map.

That is, the inverse feature-map converter 1120 performs inverse conversion on the (reconstructed) converted feature map, thereby generating a (reconstructed) feature map having a form similar to that of the first feature map extracted by the feature map extractor 1010.

The reconstructed feature map may be input to a means of performing a task, and may be used for various machine tasks.

FIG. 15 is a structural diagram of a feature map converter according to an example.

The feature map converter 1020 may include a feature map size adjuster 1210, a feature map quantizer 1220, and a feature map arranger 1230.

The feature map size adjuster 1210 may adjust the size of a feature map.

The feature map quantizer 1220 performs quantization on the feature map, thereby generating a quantized feature map.

The feature map arranger 1230 performs arrangement on the (quantized) feature map, thereby generating an arranged feature map.

The arranged feature map may be the above-described converted feature map. When arrangement is not performed, the quantized feature map may be the above-described converted feature map.

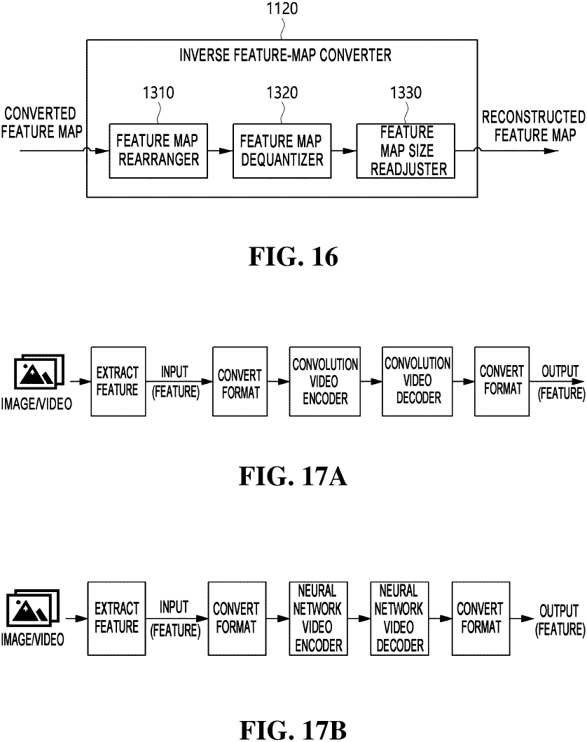

FIG. 16 is a structural diagram of an inverse feature-map converter according to an example.

The inverse feature-map converter 1120 may include a feature map rearranger 1310, a feature map dequantizer 1320, and a feature map size readjuster 1330.

The feature map rearranger 1310 performs rearrangement on the (reconstructed) converted feature map, thereby generating a rearranged feature map.

The rearranged feature map may correspond to the quantized feature map in the encoding apparatus 1000.

The feature map dequantizer 1320 performs dequantization on the rearranged feature map, thereby generating a dequantized feature map.

When arrangement is not performed in the encoding apparatus 1000 or when rearrangement is not performed in the feature map rearranger 1310, the feature map dequantizer 1320 performs dequantization on the (reconstructed) converted feature map, thereby generating a dequantized feature map.

The feature map size readjuster 1330 may readjust the size of the dequantized feature map.

The reconstructed feature map may be the dequantized feature map having the size readjusted by the feature map size readjuster 1330.

Alternatively, the reconstructed feature map may be the dequantized feature map, and the feature map size readjuster 1330 may readjust the size of the reconstructed feature map.

### Feature Map Encoding Based on Existing Image Encoding Apparatus and Decoding Apparatus

FIG. 17A illustrates an example of performing feature map encoding based on an existing image encoding apparatus and decoding apparatus, such as HEVC and VVC.

FIG. 17B illustrates an example of using an artificial neural network for feature map encoding.

In order to use a feature-map-encoding system in various situations, it may be advantageous for the system to support various types of feature map extraction methods and feature map conversion methods.

To this end, in embodiments, parameters used in a feature map extraction process or information about a feature map extraction method (e.g., feature map information) may also be encoded by the feature map encoder 1030 when such information is required, and the encoded parameters and the encoded information may be included in a bitstream or a computer-readable recording medium. Also, the encoded parameters and the encoded information may be finally transferred to the means of performing a task.

### Feature Map Channel Size Adjustment to Which Super Resolution Technique is Applied

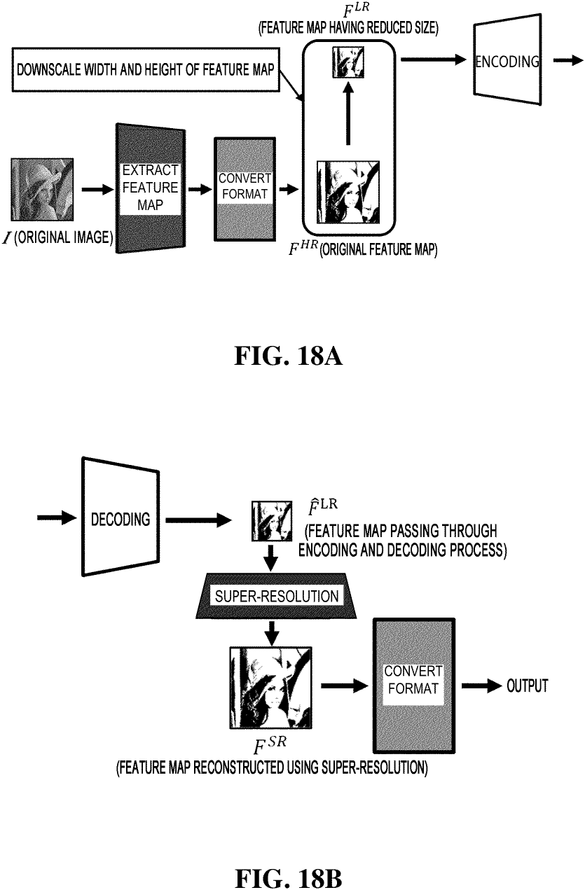

FIG. 18A and FIG. 18B illustrate feature map channel size adjustment to which a super-resolution technique is applied.

FIG. 18A illustrates encoding using adjustment of the size of a feature map channel according to an example.

FIG. 18B illustrates decoding to which a super-resolution technique is applied according to an example.

The output of encoding of FIG. 18A may be input of decoding of FIG. 18B.

The size of each channel of a feature map in embodiments may be adjusted by a super-resolution technique that is applied after decoding.

FIG. 18A and FIG. 18B illustrate feature map channel size adjustment to which a super-resolution technique is applied.

First, a feature map extraction means (feature map extractor) may extract a feature map from an original image. The original image may be an input image.

The extracted feature map may be converted into a format suitable for encoding when it passes through a first feature map conversion means (format converter). That is, first format conversion is performed on the feature map, whereby an original feature map may be generated. The first format conversion may include processes such as quantization, padding, size adjustment, and/or rearrangement.

Subsequently, downscaling for reducing the width and height of the original feature map using an interpolation method or the like is performed, whereby a low-resolution feature map may be generated from the converted feature map.

The low-resolution feature map may be compressed using a feature map encoder. The low-resolution feature map is compressed using the feature map encoder, whereby a compressed low-resolution feature map may be generated. Here, the compression may mean encoding.

The low-resolution feature map may be reconstructed using a feature map decoder. The compressed low-resolution feature map is decompressed using the feature map decoder, whereby a reconstructed low-resolution feature map may be generated. Here, the decompression may mean decoding.

As a feature map decompression codec, an existing image compression codec or a compression codec based on an artificial neural network may be used, like in the process of encoding the feature map, or a decompression codec corresponding to the compression codec may be used as the feature map decompression codec.

A “reconstructed” feature map may mean the feature map that passes through an encoding and decoding process.

The reconstructed low-resolution feature map may be upscaled using a super-resolution technique so as to be a reconstructed feature map having the original resolution size (of the original feature map). A reconstructed feature map may be generated from the reconstructed low-resolution feature map through upscaling.

As the super-resolution technique, an artificial neural network may be used.

The reconstructed converted feature map may be restored to the original format of the original image by passing through a second feature map conversion means (format converter). That is, second format conversion is performed on the feature map, whereby a reconstructed original image may be generated. The second format conversion may include processes, such as dequantization, cropping, size readjustment, and/or inverse rearrangement. The first format conversion and the second format conversion may correspond to each other.

When learning for a super-resolution technique is performed in an artificial neural network, a result of compression and reconstruction of a feature map may be used as training data for training. Through such training, compression artifacts of the feature map may be reduced, and simultaneously, the resolution of the reconstructed (converted) feature map may be improved. Also, through such training, the feature map encoding performance may be improved.

At least one of the steps including downscaling/upscaling and encoding/decoding may be skipped. When a specific step is skipped, a modifier corresponding thereto, among modifiers such as “low-resolution” and “compressed/reconstructed”, which are related to the above-described feature map, may be deleted.

### Determination of Encoding Feature Map and Resolution Adjustment

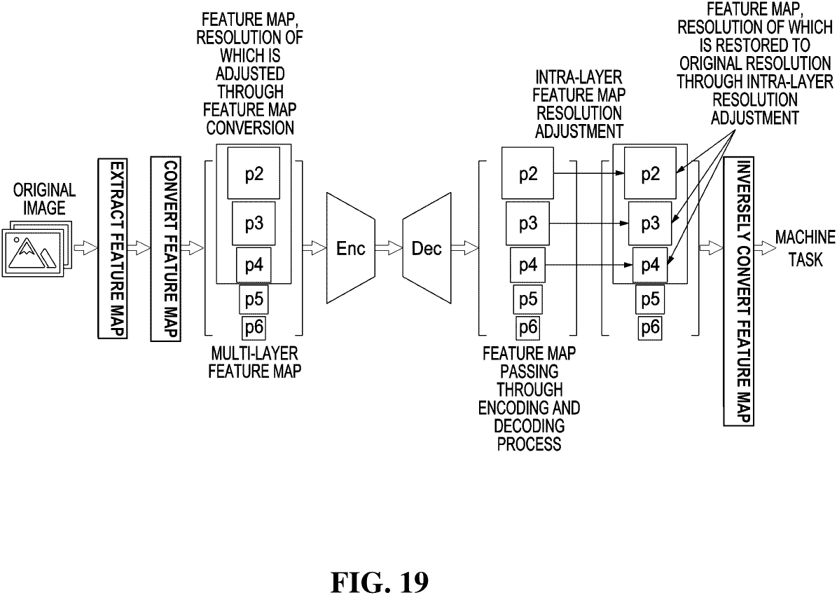

FIG. 19 illustrates a method for adjusting resolution of a feature map within a layer.

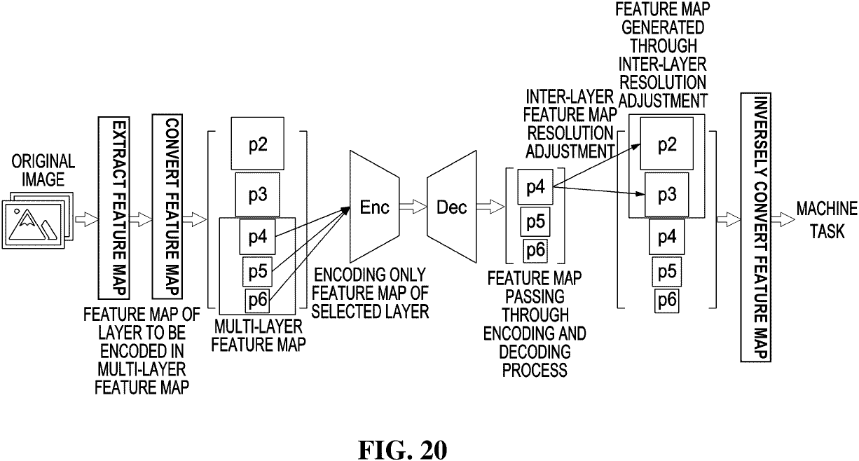

FIG. 20 illustrates a method for adjusting resolution of a feature map between layers.

When the resolution of a feature map is adjusted by a means of converting a feature map and is then restored through a means of inversely converting the feature map, the amount of compressed bits may be reduced and degradation in machine vision performance may be minimized.

According to an embodiment, when feature map encoding is performed, various feature map resolution adjustment methods may be applied, and a different encoding feature map is decided on for each feature map depending on the characteristics of the feature map, whereby optimal performance may be achieved.

In the example of FIG. 19, encoding feature maps may correspond to feature maps acquired by adjusting the respective resolution sizes of the feature maps P2, P3 and P4. For example, in FIG. 19, the encoding feature maps may correspond to feature maps acquired by adjusting the resolution sizes of the feature maps P2, P3 and P4 so as to be lower than the resolution of the original feature maps.

In the example of FIG. 20, the encoding feature maps may correspond to the feature maps P4, P5 and P6. That is, only the feature maps P4, P5 and P6 are encoded and transmitted to a decoding apparatus, and the decoding apparatus may reconstruct feature maps P2 and P3 using the feature maps P4, P5, and P6. In the example of FIG. 20, the feature maps P2 and P3 are reconstructed based on the feature map P4.

In order to adjust the resolution of a feature map, an intra-layer feature map resolution adjustment method or an inter-layer resolution adjustment method may be used. Intra-layer feature map resolution adjustment may be applied both to a single-layer feature map and to a multi-layer feature map, and inter-layer resolution adjustment may be applied to a multi-layer feature map.

In the intra-layer feature map resolution adjustment method, the resolution of a feature map of a single layer may be adjusted such that the feature map turns into another feature map having different resolution at the same layer. In the inter-layer feature map resolution adjustment method, the resolution of a feature map of one layer may be adjusted such that the feature map turns into another feature map having different resolution at a different layer.

FIG. 19 and FIG. 20 illustrate examples of intra-layer feature map resolution adjustment and inter-layer feature map resolution adjustment in a multi-layer feature map.

In order to adjust the resolution of a feature map, an interpolation method or a super-resolution method may be used. As the resolution adjustment method of the present disclosure, an interpolation method, a super-resolution method, and the like may be applied.

As the interpolation method, nearest neighbor, bilinear, and bicubic interpolation may be used, and as the super-resolution method, an artificial neural network may be used.

When learning for application of the super-resolution technique is performed, a result acquired by reconstructing a feature map after compressing the same may be used as training data, whereby resolution may be improved and compression artifacts of the feature map may be reduced. Accordingly, the feature map encoding performance may be greatly improved.

### Method of Encoding/Decoding Feature Map

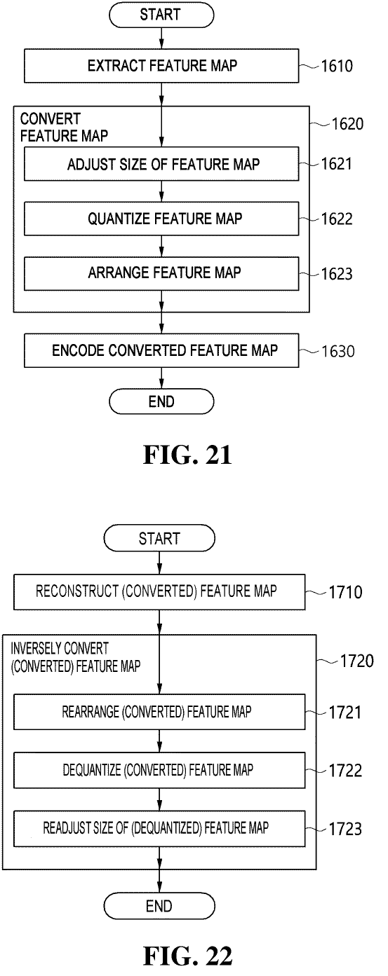

FIG. 21 is a flowchart of a method for encoding a feature map according to an embodiment.

At step 1610, the feature map extractor 1010 may extract a feature map from an input image.

At step 1620, the feature map converter 1020 may convert the extracted feature map into a format suitable for encoding.

The feature map converter 1020 performs conversion on the extracted feature map, thereby generating a converted feature map.

The feature map may include one or more channels. Hereinafter, a feature map channel may mean the channel of a feature map.

Step 1620 may include steps 1621, 1622 and 1623.

At step 1621, the feature map size adjuster 1210 may adjust the size of the feature map.

The feature map size adjuster 1210 may perform processing on information about each channel of the feature map such that the size of the channel of the feature map satisfies a specific condition based on the size of a block used in the feature map encoder 1030. The processing may include upscaling, downscaling, padding, and cropping.

The specific condition may include one or more of a first specific condition, or a second specific condition, or a combination thereof.

The first specific condition may be that the width of each channel is required to be an integer multiple of the width of the block used in the feature map encoder 1030. The first specific condition may be that the height of each channel is required to be an integer multiple of the height of the block used in the feature map encoder 1030. The first specific condition may be that the width and height of each channel are respectively required to be an integer multiple of the width of the block used in the feature map encoder 1030 and an integer multiple of the height of the block used in the feature map encoder 1030.

The second specific condition may be that the width of the block used in the feature map encoder 1030 is required to be an integer multiple of the width of each channel. The second specific condition may be that the height of the block used in the feature map encoder 1030 is required to be an integer multiple of the height of each channel. The second specific condition may be that the width and height of the block used in the feature map encoder 1030 are respectively required to be an integer multiple of the width of each channel and an integer multiple of the height of the channel.

The feature map size adjuster 1210 may perform downscaling on the feature map.

The feature map size adjuster 1210 may perform downscaling on the size of each channel of the feature map.

The feature map size adjuster 1210 performs downscaling on the feature map, thereby generating a low-resolution feature map. Alternatively, the feature map size adjuster 1210 performs downscaling on the size of each channel of the feature map, thereby generating a low-resolution feature map. The low-resolution feature map may be a downscaled feature map.

In embodiments, downscaling may be optionally performed. The feature map may mean a low-resolution feature map. Particularly, the feature map at steps after step 1621 may be a low-resolution feature map. At step 1622, the feature map quantizer 1220 performs quantization on the feature map, thereby generating a quantized feature map.

At step 1623, the feature map arranger 1230 performs arrangement on the (quantized) feature map, thereby generating an arranged feature map.

The arranged feature map may be the above-described converted feature map. When arrangement is not performed, the quantized feature map may be the above-described converted feature map.

The feature map arranger 1230 may temporally and/or spatially arrange one or more channels of the (quantized) feature map.

The feature map arranger 1230 may perform at least one of 1) spatial arrangement of the channels, 2) temporal arrangement of the channels, or 3) spatiotemporal arrangement of the channels, or a combination thereof.

At step 1630, the feature map encoder 1030 may perform encoding on the converted feature map.

The feature map encoder 1030 performs encoding on the converted feature map, feature map information, and feature map conversion information, thereby generating information about the (encoded) feature map.

The encoding may include compression.

The feature map information may be information about the feature map to be encoded.

The feature map information may include at least one of 1) the width of a channel of the feature map, 2) the height of the channel of the feature map, 3) the coefficients of one or more channels of the feature map, 4) layer information of the feature map, or 5) feature map extraction information, or a combination thereof.

The feature map conversion information may be information about the parameters used for the conversion of the feature map.

The feature map conversion information may include at least one of 1) a parameter related to adjustment of the sizes of one or more channels of the feature map, 2) a parameter related to quantization of the feature map, or 3) a parameter related to arrangement of the one or more channels of the feature map, or a combination thereof.

The information about the (encoded) feature map may be transmitted to the decoding apparatus 1100 through a bitstream or the like, and may be stored in a computer-readable recording medium, or the like.

The feature map encoder 1030 may generate a bitstream including the information about the feature map, and may store the information about the feature map in a computer-readable recording medium, or the like.

FIG. 22 is a flowchart of a method for decoding a feature map according to an embodiment.

At step 1710, the feature map decoder 1110 performs decoding on the information about the (encoded) feature map, which is stored in the bitstream input to the decoding apparatus 1100 or in a computer-readable recording medium, thereby reconstructing the converted feature map.

The feature map decoder 1110 performs decoding on the information about the (encoded) feature map, thereby generating a (reconstructed) converted feature map, feature map information, and feature map conversion information.

The decoding may include decompression.

The feature map information may be information about the feature map to be decoded.

The feature map information may include at least one of 1) the width of a channel of the feature map, 2) the height of the channel of the feature map, 3) the coefficients of one or more channels of the feature map, 4) layer information of the feature map, or 5) feature map extraction information, or a combination thereof.

The feature map conversion information may be information about the parameters used for the conversion of the feature map.

The feature map conversion information may include at least one of 1) a parameter related to adjustment of the sizes of one or more channels of the feature map, 2) a parameter related to quantization of the feature map, or 3) a parameter related to arrangement of the one or more channels of the feature map, or a combination thereof.

At step 1720, the inverse feature-map converter 1120 performs inverse conversion on the (reconstructed) converted feature map, thereby generating a (reconstructed) feature map.

That is, the inverse feature-map converter 1120 performs inverse conversion on the (reconstructed) converted feature map, thereby generating a (reconstructed) feature map having a form similar to that of the first feature map extracted by the feature map extractor 1010.

Step 1720 may include steps 1721, 1722 and 1723.

At step 1721, the feature map rearranger 1310 performs rearrangement on the (reconstructed) converted feature map, thereby generating a rearranged feature map.

The rearranged feature map may correspond to the quantized feature map in the encoding apparatus 1000.

The feature map rearranger 1310 may temporally and/or spatially arrange one or more channels of the (reconstructed) converted feature map.

The feature map rearranger 1310 may perform at least one of 1) spatial rearrangement of the channels, 2) temporal rearrangement of the channels, or 3) spatiotemporal rearrangement of the channels, or a combination thereof.

At step 1722, the feature map dequantizer 1320 performs dequantization on the rearranged feature map, thereby generating a dequantized feature map.

When arrangement is not performed in the encoding apparatus 1000 or when rearrangement is not performed in the feature map rearranger 1310, the feature map dequantizer 1320 performs dequantization on the (reconstructed) converted feature map, thereby generating a dequantized feature map.

In embodiments, selective upscaling may be performed on the (reconstructed) dequantized feature map. The (reconstructed) dequantized feature map may mean the (reconstructed) dequantized low-resolution feature map. Particularly, the (reconstructed) dequantized feature map at steps before step 1723 may be the (reconstructed) dequantized low-resolution feature map.

At step 1723, the feature map size readjuster 1330 may perform upscaling using super-resolution on the (reconstructed) dequantized feature map.

The feature map size readjuster 1330 may perform upscaling using super-resolution on the size of each channel of the (reconstructed) dequantized feature map. Here, the channel may be the downscaled channel to which downscaling was applied at step 1621.

The feature map size readjuster 1330 performs upscaling using super-resolution on the (reconstructed) dequantized low-resolution feature map, thereby generating a (reconstructed) dequantized feature map. Alternatively, the feature map size readjuster 1330 performs upscaling using super-resolution on the size of each channel of the (reconstructed) dequantized low-resolution feature map, thereby generating a (reconstructed) dequantized feature map.

The upscaling using super-resolution may be performed using a neural network.

Here, when training of the neural network is performed, a result generated by applying compression and reconstruction to the feature map may be used as training data for the training. Alternatively, when training of the neural network is performed, a result generated by applying encoding and decoding to the feature map may be used as training data for the training. For example, when training of the neural network is performed, the original image and the reconstructed image may be used as training data for the training.

The feature map size readjuster 1330 may readjust the size of the dequantized feature map.

The feature map size readjuster 1330 may perform processing on information about each channel of the feature map such that the size of the channel of the feature map satisfies a specific condition based on the size of a block used in the feature map encoder 1030. The processing may include upscaling, downscaling, padding, and cropping.

The specific condition may be one or more of a first specific condition, or a second specific condition, or a combination thereof.

The first specific condition may be that the width of each channel is required to be an integer multiple of the width of the block used in the feature map encoder 1030. The first specific condition may be that the height of each channel is required to be an integer multiple of the height of the block used in the feature map encoder 1030. The first specific condition may be that the width and height of each channel are respectively required to be an integer multiple of the width of the block used in the feature map encoder 1030 and an integer multiple of the height of the block used in the feature map encoder 1030.

The second specific condition may be that the width of the block used in the feature map encoder 1030 is required to be an integer multiple of the width of each channel. The second specific condition may be that the height of the block used in the feature map encoder 1030 is required to be an integer multiple of the height of each channel. The second specific condition may be that the width and height of the block used in the feature map encoder 1030 are respectively required to be an integer multiple of the width of each channel and an integer multiple of the height of the channel.

The reconstructed feature map may be the dequantized feature map having the size readjusted by the feature map size readjuster 1330.

Alternatively, the reconstructed feature map may be the dequantized feature map, and the feature map size readjuster 1330 may readjust the size of the reconstructed feature map.

The reconstructed feature map may be input to the means of performing a task, and may be used for various machine tasks.

### Setting Block Size of Feature Map Encoder Used for Adjustment of Size of Channel of Feature Map

With regard to step 1621 and step 1723, the following descriptions may be applied.

In most image coding techniques, such as JPEG, AVC, AV1, HEVC, VVC, and the like, the maximum size of a block that can be used for actual coding may be generally limited in order to facilitate implementation.

For example, in AVC, a coding block may be limited to a MacroBlock (MB) having luminance samples, of which the maximum size represented as width × height is 16 × 16.

In another example, in HEVC and VVC, the maximum size of a coding block may be limited to the size of a Coding Tree Block (CTB), and the maximum size of a frequency transform block may be limited to a maximum transform size.

Unlike in AVC, in HEVC and VVC, the maximum size of a coding block and the maximum size of a frequency transform block may be set in the encoding apparatus depending on the characteristics of the actually input sequence.

Such a block having the maximum size may be generally partitioned into smaller blocks for more efficient prediction and transform in the encoding process.

For example, in the encoding process of HEVC, a coding block may be partitioned to take the form of a quadtree or the like such that the actual size of the coding block becomes smaller than the size of a CTB. Also, a transform block may be partitioned to take the form of a quadtree or the like such that the actual size of the transform block becomes smaller than the maximum transform size.

The size of a feature map may be affected by the size of an input image. Accordingly, the size of the feature map may be adjusted by adjusting the size of the input image, and depending on such adjustment, the size of the feature map may be adjusted to the size of the coding block.

For example, when the size of the input image is adjusted to a specific size, such as 1024 × 768, the size of the feature map that is first output may be 256 × 192, which is a multiple of the size of a block.

In embodiments, a block size in the input image and the feature map encoder 1030, which is used for adjustment of the size of a channel of the feature map, may be set to a size equal to or less than the maximum block size, as in the above-described examples.

For example, when the width of the block used in the feature map encoder 1030 is W_{B}, W_{B} may be set equal to or less than the size of a CTB or the maximum transform size in HEVC and VVC.

For example, when the size of a CTB is 64 × 64, W_{B} may be set to an integer equal to or less than 64, or W_{B} may be set to satisfy W_{B} = 2^{k} (k being an integer greater than 1).

In an embodiment, setting W_{B} to satisfy W_{B} = 2^{k} (k being an integer greater than 1) (that is, setting W_{B} to one of powers of 2, such as 64, 32, 16, 8, and 4) may be more advantageous than setting W_{B} to a value equal to or less than 64, such as 48 or 24, because it may respond to the case in which a feature map is extracted in a such a way that the width and height thereof are reduced by ½ thereof as in an FPN.

Also, W_{B} may be set to the largest value satisfying a given specific condition. By setting W_{B} to the largest value satisfying the given specific condition, encoding performance may be maximized.

### Super-Resolution Means to Be Used for Adjusting Size of Feature Map Channel

With regard to super-resolution at step 1621 and step 1723, the following descriptions may be applied.

Before an input image is input to a super-resolution artificial neural network, such as a Deeply-Recursive Convolutional Network (DRCN), Very-Deep Super-Resolution (VSDR), Dense Super-Resolution (DenseSR), or the like, bicubic interpolation is used for the input image, whereby the original image may turn into a low-resolution image. That is, bicubic interpolation is applied to the original image, whereby a low-resolution image may be generated from the original image and then input to the super-resolution artificial neural network.

When a low-resolution image is generated, a scale factor may be set. The scale factor may be an integer or a real number.

When the low-resolution image is restored to a high-resolution image, the above-described super-resolution artificial neural network may be used. Using the super-resolution artificial neural network, the low-resolution image may be restored to an image having the high resolution of the original image. Here, the low-resolution image may be restored to the image having the high resolution of the original image using the set scale factor.

The feature map to be encoded may be stored as an image-type file using embodiments. Compared to encoding the feature map stored as an image-type file, encoding a feature having a reduced width and height may more reduce a compression bitrate.

For example, when a feature map has four pixels in each of a horizontal direction and a vertical direction, this feature map may have a total of 16 pixels. Each of scale factors for downscaling the feature map in the horizontal direction and the vertical direction may be set to ½, and a low-resolution feature map may be generated depending on the scale factors. This low-resolution feature map may have only four pixels, and it can be seen that the bitrate in encoding is reduced to ¼ through simple calculation.

For the feature map having the reduced size, an encoding and decoding process using the existing image compression codec (e.g., HEVC and VVC) or artificial neural network compression codec (e.g., end-to-end neural network) may be performed. The decoded low-resolution feature map may be input to the super-resolution neural network, and the feature map having the resolution of the original feature map may be reconstructed through the super-resolution neural network.

### Condition for Adjustment of Size of Feature Map Channel

With regard to the specific condition at step 1621 and step 1723, the following descriptions may be applied.

According to embodiments, the size of each channel of a feature map is required to be set to satisfy a specific condition based on the size of a block in the above-described feature map encoder 1030.

The specific condition may be one or more of the following condition 1, condition 2, condition 3, or condition 4, or a combination thereof.

[condition 1] the width and/or the height of each channel is required to be an integer multiple of the width and/or the height of a block used in the feature map encoder 1030.

[condition 2] the width and/or the height of the block used in the feature map encoder 1030 is required to be an integer multiple of the width and/or the height of each channel.

For example, when the width of the block of the feature map encoder 1030 is W_{B} and when the width of the channel of the feature map is W_{C}, the above condition 1) and condition 2) may be represented as condition 3) and condition 4) including the following equations.

$${\text{W}}_{\text{C}} = \text{m} ⋅ {\text{W}}_{\text{B}} \left(\text{m being a positive integer}\right) \qquad \text{[condition 3]}$$

$${\text{W}}_{\text{B}} = \text{n} ⋅ {\text{W}}_{\text{C}} \left(\text{n being a positive integer}\right) \qquad \text{[condition 4]}$$

For example, when W_{B} is 64 and when W_{C} is 256, because m is 4 (m = 4), condition 1 is satisfied, but condition 2 is not satisfied because n is less than 1 (n < 1).

In another example in which W_{B} is 64, 1) when W_{C} is 224, because m is 3.5 and n is less than 1 (m = 3.5 and n < 1), neither condition 1 nor condition 2 may be satisfied. 2) When W_{C} is 32, because m is less than 1 and n is 2 (m < 1 and n = 2), condition 1 may not be satisfied, but condition 2 may be satisfied. 3) When W_{C} is 64, both condition 1 and condition 2 may be satisfied.

In the encoding apparatus 1000 for the feature map, the size of a block (e.g., width × height) may be generally set to a power of 2, such as 2^{k} × 2¹, for reasons such as block partitioning and calculation efficiency. Here, k may be an integer equal to or greater than 1, and l may be an integer equal to or greater than 1. For example, blocks having sizes corresponding to powers of 2 may be used in the video-processing methods, such as AVC, HEVC, and VVC.

The feature map size adjuster 1210 of the encoding apparatus 1000 may adjust the size of a channel of the feature map using upscaling, downscaling, padding, and the like such that the width and/or the height of the channel satisfy at least one of the above-described conditions.

For example, when W_{B} = 64 and W_{C} = 192 are satisfied, W′_{C}, which is the width of the channel having an adjusted size, is set to 256, after which the feature map size adjuster 1210 may adjust the width of the channel to become W′_{C} by using upscaling and/or padding.

The feature map size readjuster 1330 of the decoding apparatus 1100 may readjust the size of the channel of the feature map, which is adjusted in the encoding process, to become equal to the original size of the channel.

For example, when the feature map size adjuster 1210 upscales the width of the channel satisfying W_{C} = 192 so as to satisfy W′_{C} = 256, the feature map size readjuster 1330 may downscale the width of the channel satisfying W′_{C} = 256 so as to satisfy W_{C} = 192.

For example, when the feature map size adjuster 1210 performs padding such that the width of the channel satisfying W_{C} = 192 is changed to satisfy W′_{C} = 256, the feature map size readjuster 1330 may crop the padding such that the width of the channel satisfying W′_{C} = 256 is changed to satisfy W_{C} = 192.

### Feature Map Channel Size Adjustment Using Super-Resolution Technique

Separately from the above-described adjustment of the size of a feature map channel based on the size of a block of the encoding apparatus 1000 for a feature map, adjustment of the size of the feature map may be performed using a super-resolution technique.

In embodiments, the super-resolution technique may be a technique for reconstructing a high-resolution feature map from a low-resolution feature map. Therefore, the process of generating a low-resolution feature map by downscaling the original feature map (e.g., step 1621) and the process of reconstructing a feature map having the original resolution from the low-resolution feature map using a super-resolution means (e.g., step 1723) may be required.

For example, at step 1621, when the width and height of the original feature map are 272 × 200, the size (that is, the resolution) may be adjusted as follows depending on a horizontal downscaling factor and a vertical downscaling factor for the feature map.
When the horizontal scaling factor is ½ and when the vertical scaling factor is ½, the size of the downscaled feature map may be 136 × 100.
When the horizontal scaling factor is ½ and when the vertical scaling factor is ¼, the size of the downscaled feature map may be 136 × 50.
When the horizontal scaling factor is ¼ and when the vertical scaling factor is ½, the size of the downscaled feature map may be 68 × 100.

For example, when scaling factors for downscaling are used, as described above, upscaling may be performed at step 1723 by using the reciprocals of the values of the scaling factors for downscaling used at step 1621 as scaling factors.
When the size of a low-resolution feature map is 136 × 100 and when the horizontal scaling factor and the vertical scaling factor are ½ and ½, respectively, the size of a reconstructed feature map having the original resolution may be 272 × 200.
When the size of a low-resolution feature map is 136 × 50 and when the horizontal scaling factor and the vertical scaling factor are ½ and ¼, respectively, the size of a reconstructed feature map having the original resolution may be 272 × 200.
When the size of a low-resolution feature map is 68 × 100 and when the horizontal scaling factor and the vertical scaling factor are ¼ and ½, respectively, the size of a reconstructed feature map having the original resolution may be 272 × 200.

When learning for the super-resolution technique is performed, a result acquired by compressing a feature map and reconstructing the compressed feature map is used as training data for the learning, whereby the compression artifacts of the feature map may be reduced and the resolution of the feature map may be improved. By reducing the compression artifacts of the feature map and improving the resolution of the feature map, encoding performance may be greatly improved.

### Adjustment of Size of Feature Map Channel

The following descriptions may be applied with regard to size adjustment at step 1621 and step 1723.

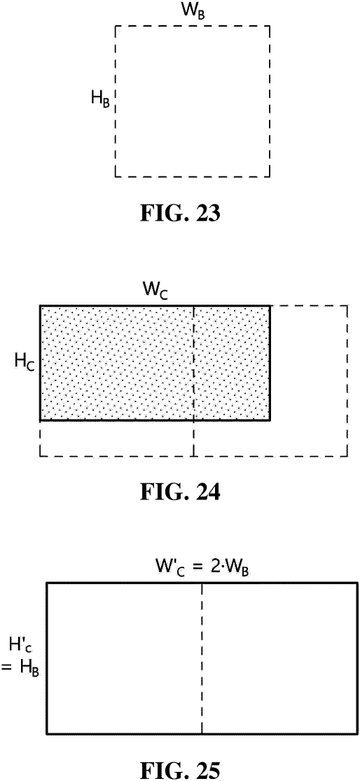

FIG. 23 illustrates the size of a coding block according to an example.

The dotted line in FIG. 23 indicates the size of the coding block.

FIG. 24 illustrates a channel of a feature map before the size is adjusted according to an example.

The shaded part in FIG. 24 indicates the channel of the feature map before the size is adjusted.

The region surrounded with the dotted line in FIG. 24 indicates the size of the channel of the feature map after the size is adjusted.

FIG. 25 illustrates a channel of a feature map after the size is adjusted according to an example.

In FIG. 25, the size of the channel of the feature map is adjusted to be equal to the size of a coding block.

Referring to the examples illustrated in FIG. 23, FIG. 24, and FIG. 25, when the width and height of a block are respectively set to W_{B} = 64 and H_{B} = 64 in the feature map encoder 1030 and when the width and height of a channel of a feature map are respectively set to W_{C} = 96 and H_{C} = 48, the size of the channel of the feature map may be adjusted such that the width and height thereof respectively satisfy W′_{C} = 2 · W_{B} = 128 and H′_{C} = H_{B} = 64 in embodiments.

In the above channel size adjustment, the size of the channel has to be adjusted to increase, so the size of the channel may be increased using a method such as up-sampling and/or padding.

FIG. 23, FIG. 24, and FIG. 25 respectively show 1) the size of the coding block, 2) the size of the channel of the feature map before the size is adjusted, and 3) the size of the channel of the feature map after the size is adjusted according to the above embodiment.

When the size of the channel is adjusted to decrease, the size may be decreased using a method such as downsampling or cropping.

### Size Adjustment and Size Readjustment by Up-Sampling and Downsampling

The following descriptions may be applied with regard to size adjustment at step 1621 and step 1723.

In the above-described embodiment, a channel may have a size of 96 × 48 before size adjustment, and the size of the channel has to change to 128 × 64 after size adjustment. Accordingly, it is required to up-sample the width and the height to 4/3 times the width and 4/3 times the height, respectively.

Various methods, such as a bilinear method, a bicubic method, a Lanczos method, an HEVC interpolation filter, a VVC interpolation method, a method using deep learning, and the like, may be used for up-sampling, and it may be more advantageous to use a simple method in terms of calculation amounts.

The channel that is up-sampled at the time of encoding the feature map is downsampled when decoding is performed, thereby being readjusted to have the same size as the original size.

That is, in the above-described embodiment, the channel may have a size of 128 × 64 after size adjustment, and because the original size of the channel is 96 × 48, the width and the height have to be downsampled to ¾ times the width and ¾ times the height, respectively.

Various methods, such as sampling, low-pass sampling, Scalable Video Coding (SVC), a downsampling filter, and the like, may be used for downsampling, and it may be more advantageous to use a simple method in terms of calculation amounts.

In contrast to the above-described embodiment, when the size of the channel is adjusted to decrease, the size may be adjusted by downsampling at the time of encoding the feature map, and the size may be readjusted by up-sampling at the time of decoding the feature map.

### Adjustment and Readjustment of Size by Padding And/or Cropping

The following descriptions may be applied with regard to size adjustment at step 1621 and step 1723.

In the above-described embodiment, the channel may have a size of 96 × 48 before size adjustment, and the channel is required to have a size of 128 × 64 after size adjustment. Accordingly, the feature values of 32 samples may be additionally allocated in a horizontal direction, and the feature values of 16 samples may be additionally allocated in a vertical direction.

The feature values allocated for the added samples may be acquired using a padding method. The padding method may include various methods such as repeating the same value, filling with an average value, mirror padding, interpolation, and the like.

The locations of the added samples may vary depending on how to set the relationship between the location of the channel before size adjustment and the location of the channel after size adjustment.

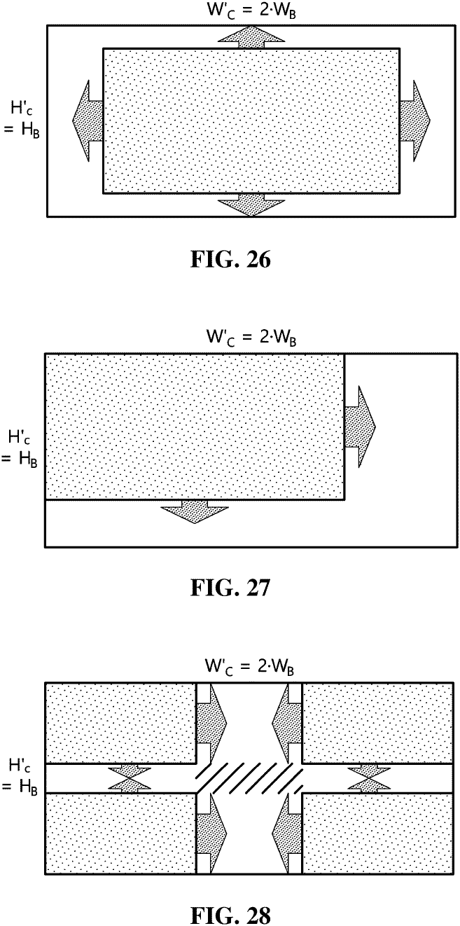

FIG. 26 illustrates the relationship between the location of information of a channel of a feature map before size adjustment and the location of the information of the channel of the feature map after size adjustment according to an example.

As illustrated in FIG. 26, the channel before size adjustment (the shaded part in FIG. 26) may be set to be located within the channel after size adjustment.

In this case, padding may be performed for the samples, to which sample values are not allocated, by using sample values near the boundary of the channel (that is, the feature values near the boundary) before size adjustment, as pointed to by the arrows in FIG. 26.

FIG. 27 illustrates the relationship between the location of information of a channel of a feature map before size adjustment and the location of the information of the channel of the feature map after size adjustment according to another example.

As illustrated in FIG. 27, the boundary of the channel before size adjustment may partially overlap the boundary of the channel after size adjustment. The relationship between the locations of the channels may be set such that the boundary of the channel before size adjustment partially overlaps the boundary of the channel after size adjustment.

In this case, padding may be performed only in the direction in which the boundaries do not overlap each other, that is, in the direction to which the arrows point in FIG. 27.

FIG. 28 illustrates the relationship between the location of information of a channel of a feature map before size adjustment and the location of the information of the channel of the feature map after size adjustment according to a further example.

As illustrated in FIG. 28, information of a channel before size adjustment may be partitioned into four segments. The relationship between the location of the partitioned channel and the location of the channel after size adjustment may be set such that parts of the boundaries of the respective segments of the channel overlap the part of the boundary of the channel after size adjustment.

In this case, when padding is performed, sample values of boundary regions in the opposite directions of the segments of the channel before size adjustment can be used, as illustrated using the arrows in FIG. 28. Therefore, a padding method, such as a linear interpolation method or a cubic interpolation method, by which the original information is better maintained, may be applied. Here, the sample values of the boundary regions may mean sample values adjacent to the boundaries and sample values, the distance from which to the boundary is equal to or less than a threshold value.

Also, for the region marked with the diagonal lines in FIG. 28, padding may be performed using the pieces of information of the samples in four directions.

The channel to which padding is applied at the time of encoding the feature map may be readjusted to have the same size as the original size at the time of decoding. When readjustment is performed, the samples with which the feature map is padded are discarded through cropping, and only the samples corresponding to the channel of the original feature map may be extracted.

When the channel of the feature map is partitioned into segments in the size adjustment process, as in FIG. 28, a process of reconstructing the channel by combining the cropping results (that is, the segments of the channel) has to be further performed in the size readjustment process.

In contrast to the above-described example, when size adjustment is performed to decrease the size of the channel, the size of the channel may be adjusted by cropping at the time of encoding the feature map, and the size of the channel may be readjusted through padding at the time of decoding the feature map.

### Size Adjustment and Readjustment Method Using Both Up-Sampling/Downsampling Method and Padding/Cropping Method

The following descriptions may be applied with regard to size adjustment at step 1621 and step 1723.

When there is a large difference between a channel size before size adjustment and the channel size after size adjustment, size adjustment using an up-sampling/downsampling method may be advantageous, whereas when there is a small difference therebetween, size adjustment using a padding/cropping method may be advantageous in many cases.

Performance may be improved by combining the two methods. That is, a size is adjusted first through padding/cropping, after which the size may be finally adjusted by performing up-sampling/downsampling, or conversely, the size is adjusted first by performing up-sampling/downsampling, after which the size may be finally adjusted through padding/cropping. Here, size readjustment may be performed in reverse order of the size adjustment.

### Adjustment of Size of Multi-Layer Feature Map Channel

The following descriptions may be applied with regard to size adjustment at step 1621 and step 1723.

When encoding and/or decoding is performed on a feature map having multiple layers, size adjustment and readjustment of embodiments may be applied to each of the multiple layers.

The same method may be applied to the multiple layers, rather than independently performing size adjustment and/or readjustment on each layer. Application of the same method may decrease calculation complexity.

For example, when the width and height of a channel of a feature map are respectively reduced to ½ times the width and ½ times the height each time the layer of the extracted feature map goes deeper by one layer, as in the FPN of a mask R-CNN, W′_{C} and H′_{C}, which are the width and height after size adjustment, may be calculated based on W_{C} and H_{C} corresponding to the size of the channel of the shallowest layer (that is, the largest channel). Then, for the layers deeper than that, the adjusted size may be calculated by reducing W′_{C} and H′_{C} to ½ times W′_{C} and ½ times H′_{C}, respectively.

In this case, W′_{C} and H′_{C}, corresponding to the size of the largest channel after being adjusted, may be set to powers of 2, such as 256, 128, 64, 32, 16, and the like. Accordingly, the result of size adjustment of all of the layers may be highly likely to be aligned with the boundary of block partitioning in the feature map encoder 1030, so this setting may be advantageous to encoding performance improvement.

### Adjustment of Size of Feature Map Channel by Adjustment of Size of Input Image

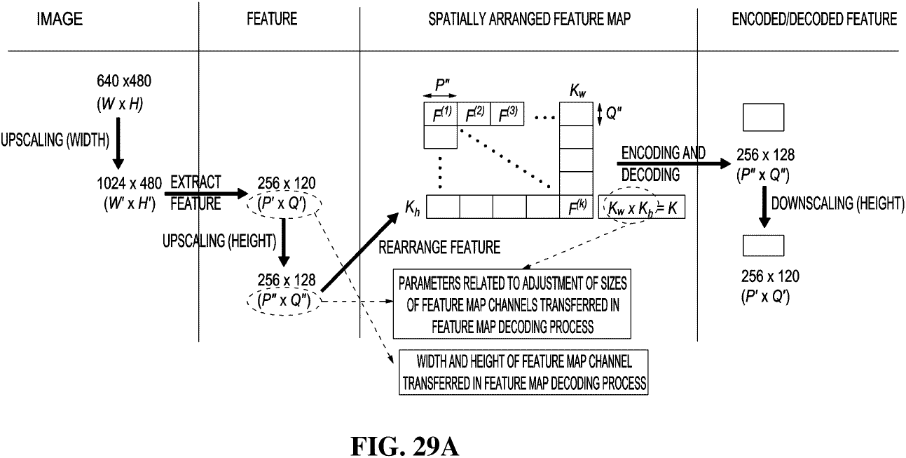

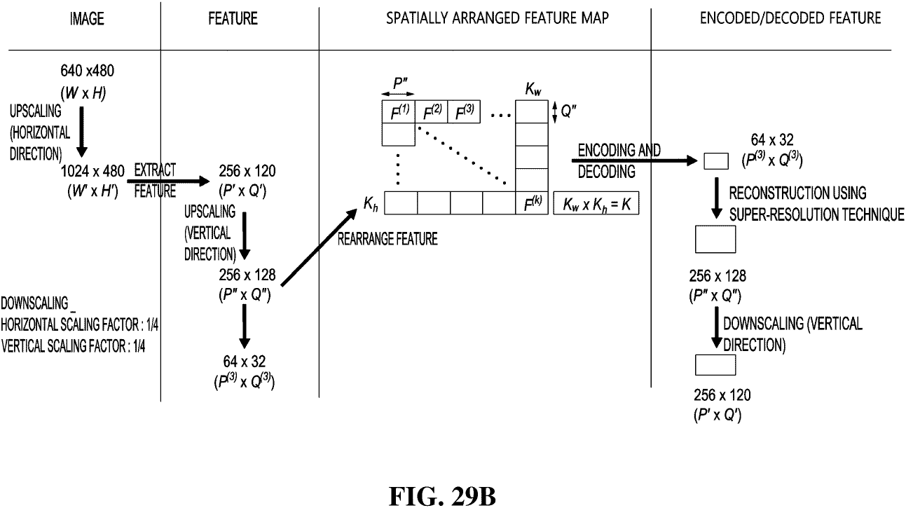

FIG. 29A illustrates adjustment of sizes of feature map channels according to an embodiment.

The following descriptions may be applied with regard to size adjustment at step 1621 and step 1723.

According to embodiments, the size of each channel of a feature map is required to be set to satisfy a specific condition based on the above-described size of the block used in the feature map encoder 1030.

The specific condition may be one or more of a first specific condition, or a second specific condition, or a combination thereof.

The first specific condition may be that the width of each channel is required to be an integer multiple of the width of the block used in the feature map encoder 1030. The first specific condition may be that the height of each channel is required to be an integer multiple of the height of the block used in the feature map encoder 1030. The first specific condition may be that the width and height of each channel are respectively required to be an integer multiple of the width of the block used in the feature map encoder 1030 and an integer multiple of the height of the block used in the feature map encoder 1030.

The second specific condition may be that the width of the block used in the feature map encoder 1030 is required to be an integer multiple of the width of each channel. The second specific condition may be that the height of the block used in the feature map encoder 1030 is required to be an integer multiple of the height of each channel. The second specific condition may be that the width and height of the block used in the feature map encoder 1030 are respectively required to be an integer multiple of the width of the channel and an integer multiple of the height of the channel.

Such adjustment of the size of a feature map channel may be performed on the feature map as in the above-described embodiments, but may be performed on the input image itself. That is, the size of the input image may be adjusted such that the size of each channel of the feature map extracted from the input image satisfies the above-described first specific condition and/or second specific condition.

The process of adjusting the size of the feature map channel by adjusting the size of the input image will be described in more detail below by taking the case in which the width or the height of the extracted feature map is reduced to 1/(a power of 2) (e.g.,½, ¼, ⅛, or the like) of the width or the height of the input image as an example.

The above-described first specific condition and second specific condition for the size of the feature map may be changed to a changed first specific condition and a changed second specific condition for the size of the input image as follows. In embodiments, the changed first specific condition and the changed second specific condition may be applied in place of the first specific condition and the second specific condition.

The changed first specific condition may be that the width of each input image is required to be an integer multiple of the width of the block used in the feature map encoder 1030. The changed first specific condition may be that the height of each input image is required to be an integer multiple of the height of the block used in the feature map encoder 1030. The changed first specific condition may be that the width and height of each input image are respectively required to be an integer multiple of the width of the block used in the feature map encoder 1030 and an integer multiple of the height of the block used in the feature map encoder 1030.

The changed second specific condition may be that the width of the block used in the feature map encoder 1030 is required to be an integer multiple of the width of each input image. The changed second specific condition may be that the height of the block used in the feature map encoder 1030 is required to be an integer multiple of the height of each input image. The changed second specific condition may be that the width and height of the block used in the feature map encoder 1030 are respectively required to be an integer multiple of the width of the input image and an integer multiple of the height of the input image.

When the width and height of the input image are W and H and when the size of the feature map channel is adjusted such that the width and height of the feature map channel are powers of 2, W′ and H′, which are the width and height of the input image having the adjusted size, may be acquired using Equation (1) and Equation (2) below:

$${\text{W}}^{′} = {2}^{\text{k}} \qquad \text{(1)}$$

Here, when the selected value of k is a natural number satisfying 2^{k-1} < W ≤ 2^{k}, the size of the feature map channel may be adjusted to increase the width of the feature map channel.

When the selected value of k is a natural number satisfying 2^{k} < W ≤ 2^{k+1}, the size of the feature map channel may be adjusted to decrease the width of the feature map channel.

$${\text{H}}^{′} = {2}^{1} \qquad \text{(2)}$$

Here, when the selected value of l is a natural number satisfying 2^{l-1} < H ≤ 2^{l}, the size of the feature map channel may be adjusted to increase the height of the feature map channel.

When the selected value of l is a natural number satisfying 2^{l} < H ≤ 2^{l+1}, the size of the feature map channel may be adjusted to decrease the height of the feature map channel.

For example, when W is 640 and when H is 480, W′ may be 1024, which is a power of 2, and H′ may be 512, which is a power of 2. Accordingly, because the size of the extracted feature map turns into a power of 2, the condition in which the size of the feature map is a multiple of the size of the block used in the feature map encoder 1030 may be satisfied.

The above-described adjustment of the size of the input image and the adjustment of the size of the feature map channel may be used in combination.

Adjustment of the width and adjustment of the height may be separately performed on different targets.

For example, adjustment of the width may be performed on the input image, and adjustment of the height may be performed on the feature map channel. Conversely, adjustment of the width may be performed on the feature map channel, and adjustment of the height may be performed on the input image.

### Combination of Adjustment of Size of Input Image and Adjustment of Size of Feature Map Channel

When it is necessary to reduce the width and height of an extracted feature map to ¼ of the width of an input image and ¼ of the height of the input image, respectively, adjustment of the width may be performed on the input image, and adjustment of the height may be performed on the feature map channel, as will be described later.

When the width of the input image is W and when the height thereof is H, the width and height of the input image after adjustment of the width may be W′ and H′, respectively (here, H may be equal to H′).

The size of the feature extracted from the input image having the adjusted width may be P′ × Q′. The size of a feature having an adjusted height, which is generated by adjusting the height of the extracted feature, may be P″ × Q″ (here, P′ may be equal to P″).

When W and H are respectively 640 and 480, W′ and H′ may become 1024 and 480, respectively, by adjusting the width of the input image, as described above. P′, which is the width of the feature extracted from the input image having a size of W′ × H′ (the input image, the width of which is adjusted), may be 256, and Q′, which is the height thereof, may be 120. P″, which is the width of the feature (having an adjusted height) generated by adjusting the height of the feature having the size of P′ × Q′, may be 256, and Q″, which is the height thereof, may be 128.

### Readjustment of Size of Reconstructed Feature Map

Readjustment of the size of a reconstructed feature map will be described below. The readjustment may be performed by the feature map decoder 1110, which inversely converts the reconstructed feature map into the format before encoding.

In order to enable the reconstructed feature generated by the decoding apparatus 1100 to be consumed by humans or machines, the reconstructed feature has to be converted to have the same size as the size of the original feature.

Rearrangement of the reconstructed feature map generated by the feature map decoder 1110 may be performed using a parameter related to adjustment of the sizes of one or more channels of the feature map.

Here, the parameter related to size adjustment may include the above-described width P″ and height Q″ of the feature having the adjusted size.

Alternatively, the parameter related to size adjustment may include 1) K_{w}, which is the number of features constituting the feature map in the horizontal direction, and 2) Kₕ, which is the number of features constituting the feature map in the vertical direction.

For example, when the feature map is rearranged to have 16 features in the horizontal direction (that is, K_{w} = 16) and to have 16 features in the vertical direction (Kₕ = 16), the width of the feature may be P″, which is the result of dividing the width of the feature map by K_{w}, and the height thereof may be Q″, which is the result of dividing the height of the feature map by Kₕ.

The width and height of the rearranged feature, which are set through the above-described process, are respectively required to be converted into P′ and Q′. Here, the values of P′ and Q′ may be transferred from the encoding apparatus 1000 to the decoding apparatus 1100 through the width of the feature map channel and the height of the feature map channel in the feature map information.

### Combination of Adjustment of Input Image Size and Feature Map Channel Size in Consideration of Feature Map Encoding Means and Adjustment of Feature Map Channel Size in Consideration of Super-Resolution

FIG. 29B illustrates adjustment of the sizes of feature map channels in consideration of super-resolution according to an example.

The above-described 1) adjustment of the size of an input image and adjustment of the size of a feature map channel in consideration of the means of encoding the feature map and 2) adjustment of the size of the feature map channel in consideration of super-resolution may be used in combination.

Here, the encoding means may indicate the feature map encoder 1030 or a feature map encoding method performed by the feature map encoder 1030.

For example, adjustment of the width in consideration of the encoding means may be performed on the input image, and adjustment of the height may be performed on the feature map channel. Conversely, adjustment of the height may be performed on the input image in consideration of the encoding means, and adjustment of the width may be performed on the feature map channel. Then, adjustment of the size of the feature map channel in consideration of super-resolution may be performed.

Also, adjustment may be performed in reverse order of the above description. For example, adjustment of the size of the feature map channel in consideration of super-resolution may be performed. Then, adjustment of the width in consideration of the encoding means may be performed on the input image, and adjustment of the height may be performed on the feature map channel. Conversely, adjustment of the height may be performed on the input image in consideration of the encoding means, and adjustment of the width may be performed on the feature map channel.

Hereinbelow, embodiments for a combination of 1) adjustment of the size of an input image and adjustment of the size of a feature map channel in consideration of the means of encoding the feature map and 2) adjustment of the size of the feature map channel in consideration of super-resolution will be described.

1) an embodiment in which, when the width and height of an extracted feature map are respectively reduced to ¼ of the width and ¼ of the height of an input image in embodiments, adjustment of the width is performed on the input image and adjustment of the height is performed on the feature map channel:
W may indicate the width of the input image. H may indicate the height of the input image. W′ may indicate the width of the above-mentioned input image after the width thereof is adjusted. H′ may indicate the height of the above-mentioned input image after the width thereof is adjusted. The width of the feature extracted from the input image, the width of which is adjusted, may be P′. The height of the feature extracted from the input image, the width of which is adjusted, may be Q′. After the height of the extracted feature is adjusted, the width of the feature, the height of which is adjusted, may be P″. Also, the height of the feature after adjustment of the height may be Q″.
When W and H are respectively 640 and 480, W′ may become 1024 by adjusting the width of the input image as described above, and H′ may become 480. P′, which is the width of the feature extracted from the input image that has a size of W′ × H′ after the width thereof is adjusted, may be 256, and Q′, which is the height of the feature, may be 120.
When the height of the feature having the size of P′ × Q′ is adjusted, P″, which is the width of the feature after the height thereof is adjusted, may become 256, and Q″, which is the height of the feature, may become 128.

2) an embodiment in which conversion of the size of a feature map channel in consideration of super-resolution is applied:
Here, each of a horizontal scaling factor and a vertical scaling factor for the feature map to be downscaled may be ¼.
P″ and Q″, which are acquired as the result of size adjustment performed on the input image and the feature map channel in consideration of the means of encoding the feature map, may be 256 and 128.
When this result is given and when the size of the feature map is adjusted based on the scaling factor for downscaling the feature map, which is set to ¼, P⁽³⁾ may become 64 and Q⁽³⁾ may become 32. Here P⁽³⁾ may be the width of the reconstructed image generated using a super-resolution technique. Q⁽³⁾ may be the height of the reconstructed image generated using the super-resolution technique.

After the above-described process is performed, the feature map passing through the compression codec may be reconstructed by performing the above-described processes in reverse order.

### Feature Map Encoding and Decoding Method Based on Inter-Layer Super-Resolution and Resolution Conversion

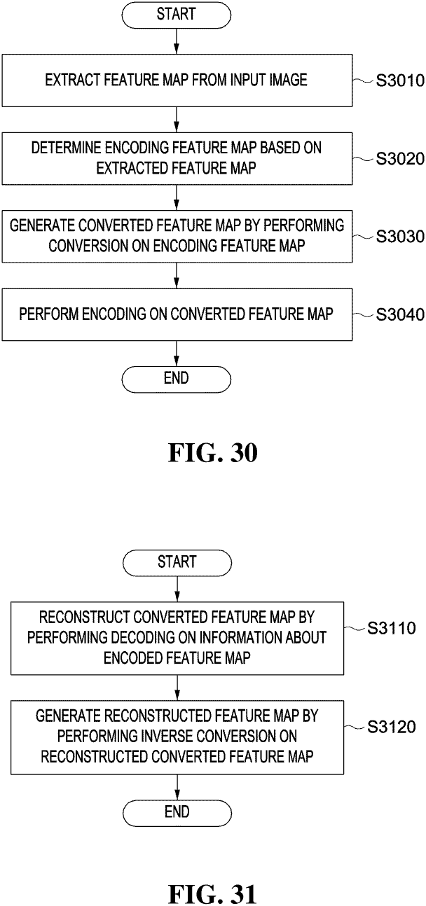

FIG. 30 is a flowchart illustrating an encoding method according to an embodiment of the present disclosure.

FIG. 31 is a flowchart illustrating a decoding method according to an embodiment of the present disclosure.

Referring to FIG. 30, the encoding method according to an embodiment of the present disclosure includes extracting a feature map from an input image at step S3010, determining an encoding feature map based on the extracted feature map at step S3020, generating a converted feature map by performing conversion on the encoding feature map at step S3030, and performing encoding on the converted feature map at step S3040.

Here, the encoding feature map may correspond to at least any one of the multi-layer feature maps extracted from the input image.

Here, generating the converted feature map at step S3030 may include adjusting the resolution of the encoding feature map.

Here, the encoding feature map may correspond to any one of a feature map, the layer and resolution of which differ from those of the feature map to be reconstructed, a feature map, the layer of which is the same as the layer of the feature map to be reconstructed, and, the resolution of which differs from the resolution of the feature map to be reconstructed, and a feature map, the layer and resolution of which are the same as those of the feature map to be reconstructed.

Here, the encoding feature map may mean some feature maps that are selected from among multiple feature maps in order to restore (reconstruct) the multiple feature maps.

Here, the encoding feature map may correspond to the feature map acquired by adjusting the resolution of the original feature map.

Here, performing the encoding at step S3040 comprises performing encoding on the converted feature map and metadata on the converted feature map, and the metadata may include information about the feature map to be reconstructed based on the encoding feature map.

Here, the metadata may further include size information of the encoding feature map when the resolution of the encoding feature map is adjusted.

Here, determining the encoding feature map at step S3020 may comprise determining the encoding feature map differently depending on the quantization parameter of the extracted feature map.

Here, the metadata includes information about a feature map reconstruction mode, and the feature map reconstruction mode may correspond to any one of an inter-layer resolution adjustment mode, an intra-layer resolution adjustment mode, or a resolution non-adjustment mode.

Referring to FIG. 31, the decoding method according to an embodiment of the present disclosure includes reconstructing a converted feature map by performing decoding on information about an encoded feature map at step S3110 and generating a reconstructed feature map by performing inverse conversion on the reconstructed converted feature map at step S3120.

Here, the encoded feature map may correspond to any one of the multi-layer feature maps extracted from an input image or the feature map, the resolution of which is adjusted.

Here, generating the reconstructed feature map at step S3120 may comprise adjusting the resolution of the reconstructed feature map.

Here, the encoded feature map may correspond to any one of a feature map, the layer and resolution of which differ from those of the feature map to be reconstructed, a feature map, the layer of which is the same as the layer of the feature map to be reconstructed, and, the resolution of which differs from the resolution of the feature map to be reconstructed, and a feature map, the layer and resolution of which are the same as those of the feature map to be reconstructed.

Here, reconstructing the converted feature map at step S3110 may comprise performing decoding on the encoded feature map and metadata on the encoded feature map, and the metadata may include information about the feature map to be reconstructed based on the encoded feature map.

Here, the metadata may further include the size information of the encoded feature map when the resolution of the encoded feature map is adjusted.

Here, the metadata includes information about a feature map reconstruction mode, and the feature map reconstruction mode may correspond to any one of an inter-layer resolution adjustment mode, an intra-layer resolution adjustment mode, and a resolution non-adjustment mode.

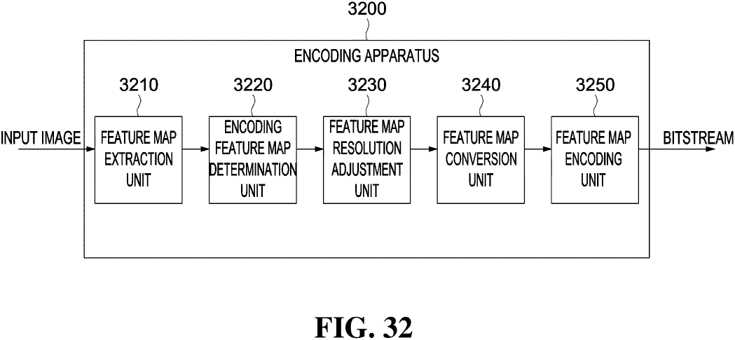

FIG. 32 is a structural diagram of an encoding apparatus according to an embodiment.

The encoding apparatus 3200 may include a feature map extraction unit 3210, an encoding feature map determination unit 3220, a feature map resolution adjustment unit 3230, a feature map conversion unit 3240, and a feature map encoding unit 3250.

The feature map extraction unit 3210 may extract a feature map from an input image.

The encoding feature map determination unit 3220 may set the number of feature maps to be encoded, among multiple feature maps, or the resolution of the feature map.

The feature map resolution adjustment unit 3230 may adjust the resolution of the encoding feature map when the resolution of the encoding feature map, determined by the encoding feature map determination unit 3220, differs from the resolution of the original feature map.

The feature map conversion unit 3240 performs conversion on the extracted feature map, thereby generating a converted feature map.

The conversion may include quantization, padding, size adjustment, arrangement, and the like of the feature map.

The feature map may be converted into a format suitable for encoding by the feature map conversion unit 3240.

The feature map encoding unit 3250 may perform encoding on the converted feature map.

The feature map encoding unit 3250 performs encoding on the converted feature map, thereby generating information about the (encoded) feature map.

The encoding may include compression.

The information about the (encoded) feature map may be transmitted to a decoding apparatus 3300 through a bitstream or the like, and may be stored in a computer-readable recording medium, or the like.

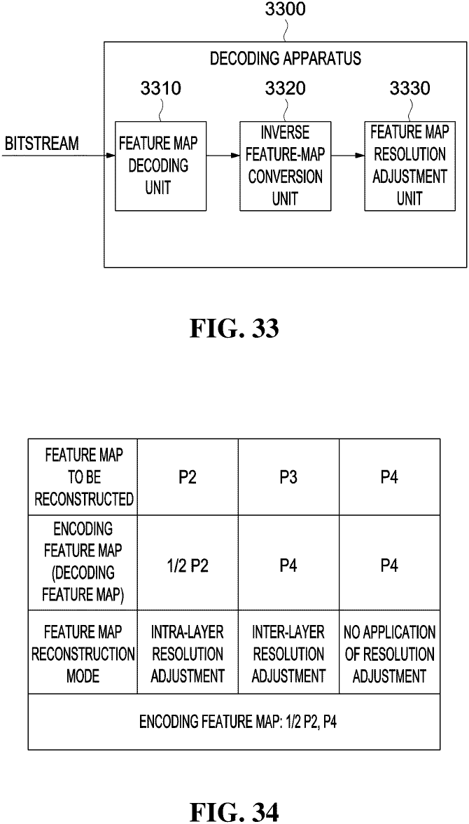

FIG. 33 is a structural diagram of a decoding apparatus according to an embodiment.

The decoding apparatus 3300 may include a feature map decoding unit 3310, an inverse feature-map conversion unit 3320, and a feature map resolution adjustment unit 3330.

The feature map decoding unit 3310 performs decoding on information about an (encoded) feature map, stored in a bitstream or a computer-readable recording medium, thereby reconstructing a converted feature map.

The inverse feature-map conversion unit 3320 performs inverse conversion on the (reconstructed) converted feature map, thereby generating a (reconstructed) feature map.

That is, the inverse feature-map conversion unit 3320 performs inverse conversion on the (reconstructed) converted feature map, thereby generating a (reconstructed) feature map having a form similar to that of the first feature map extracted by the feature map extraction unit 3210.

The feature map resolution adjustment unit 3330 may adjust the resolution sizes of the (decoded) feature maps so as to correspond to the resolution of the original feature map.

For example, the resolution of the (decoded) feature map may be adjusted using any one of an inter-layer resolution adjustment method and an intra-layer resolution adjustment method. Here, adjusting the resolution of the feature map may correspond to the process of adjusting the size of the feature map.

Here, when the resolution of the feature map to be reconstructed is the same as the resolution of the (decoded) feature map, the resolution of the (decoded) feature map may not be adjusted.

The reconstructed feature map may be input to a means of performing a task, and may be used for various machine tasks.

### Determination of Feature Map Reconstruction Mode Through Determination of Encoding Feature Map and Reconstruction of Feature Map to be Reconstructed

The encoding feature map determination unit 3220 may select an encoding feature map, among multiple feature maps. Here, the encoding feature map determination unit 3220 may additionally determine a quantization parameter and a resolution adjustment method in a decoding process. Here, the encoding feature map determination unit 3220 may make settings such that only a specific channel of the encoding feature map is encoded.

For example, when the encoding feature map for P2 is determined to be ½P2 by the encoding feature map determination unit 3220, the resolution of the feature map P2 is adjusted to the resolution of ½P2 through the feature map resolution adjustment unit 3330, after which ½P2 may be encoded. In the decoding process, ½P2, which is the decoding feature map, may be restored to have the resolution of P2, which is the feature map to be reconstructed.

For example, when the encoding feature map for P2 and P3 is determined to be P3, P3 may be encoded without encoding P2. In the decoding process, P2 and P3, which are the feature maps to be reconstructed, may be reconstructed using P3, which is the decoding feature map.

The encoding feature map and the decoding feature map may basically mean the same thing. The encoding feature map is the term used in the encoding process, and the decoding feature map is the term used in the decoding process.

Even when a single-layer feature map is encoded, the encoding feature map determination unit 3220 may select an encoding feature map. Here, the encoding feature map may be a feature map having different resolution at the same layer or a feature map having the same resolution at the same layer. For example, when a single-layer feature map is encoded by encoding only a P2 layer, among P-layer feature maps, P2 adjusted to have different resolution or P2, the resolution of which is not adjusted, may be the encoding feature map.

In the case of a multi-layer feature map, the encoding feature map may correspond to a feature map having different resolution at a different layer, a feature map having different resolution at the same layer, or a feature map having the same resolution at the same layer. A feature map reconstruction mode may be determined depending on the determined encoding feature map. For example, when a feature map having different resolution at a different layer is used as the encoding feature map, the feature map reconstruction mode may be an ‘inter-layer resolution adjustment method’. When a feature map having different resolution at the same layer is the encoding feature map, the feature map reconstruction mode may be an ‘intra-layer resolution adjustment method’. When a feature map having the same resolution at the same layer is the encoding feature map, the feature map reconstruction mode may be ‘no application of resolution adjustment’.

For example, a decoding feature map for P4, which is the feature map to be reconstructed in the decoding process, may be P5, in which case the feature map reconstruction mode may be the ‘inter-layer resolution adjustment method’. As the decoding feature map, P4 of which the resolution is adjusted may be selected, in which case the feature map reconstruction mode may be the ‘intra-layer resolution adjustment method’. When P4 of which the resolution is not adjusted is used as the decoding feature map, the feature map reconstruction mode may be ‘no application of resolution adjustment’.

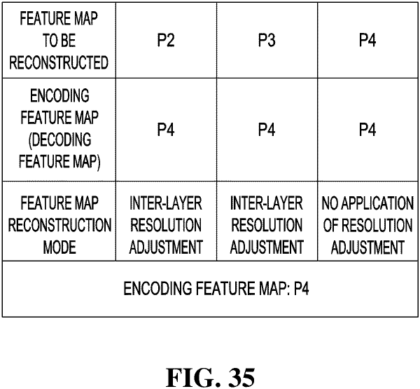

FIG. 34 and FIG. 35 are examples of determining an encoding feature map and the feature map to be reconstructed.

Because a different method may be selected as a feature map reconstruction mode for each layer or each image, an encoding feature map may be set differently for each layer or image.

As an example of selecting a feature map reconstruction mode for each layer, ½P2 may be selected as the encoding feature map for P2, which is the feature map to be reconstructed, and P2 may be reconstructed using ½P2 in the decoding process. Here, the feature map reconstruction mode may be intra-layer resolution adjustment.

When P4 is selected as the encoding feature map for P3 and P4, which are the feature maps to be reconstructed, P4 may be used in order to reconstruct P3 in the decoding process. Here, the feature map reconstruction mode may be inter-layer resolution adjustment.

Also, P4 may be used in order to reconstruct P4. Here, the feature map reconstruction mode may be no application of resolution adjustment.

Here, P5 and P6 are encoded and decoded without passing through the encoding feature map determination unit 3220, and may then be used without applying resolution adjustment. Here, the feature maps to be reconstructed are P2, P3, P4, P5, and P6, and the encoding feature maps may be ½P2, P4, P5, and P6.

Even at the same layer, a different method may be selected depending on the characteristics of the feature map, and encoding feature maps for feature maps at the same layer may differ from each other.

In order to select the most suitable encoding feature map for each feature map, various classification methods may be applied as the means of selecting an encoding feature map. For example, linear discrimination analysis (LDA), support vector machine (SVM), multi-layer perceptron (MLP), or a deep artificial neural network model for image classification may be used.

When the artificial neural network for classification is used, a task for setting classes depending on the characteristics of a feature map (that is, labelling) is required for learning. Different classes are set for respective layers, respective parameters, respective feature maps, and respective channels, whereby a neural network may be made robust to various characteristics of the feature map and a different encoding feature map may be selected depending on the characteristics of the feature map. Here, a different class may be determined depending on the characteristics of the feature map. For example, when the class of the feature map is determined so as to enable detection of objects having different sizes, it may be determined differently depending on the number or ratio of objects having different sizes in the feature map, the types of objects, whether or not an object is present, the number of objects, and the like.

When the types of selectable encoding feature maps become diversified, encoding efficiency may be more improved.

For example, when the encoding feature map for P2, which is the feature map to be reconstructed, is selected, if it is possible to select any one of P2 of which the resolution is not adjusted, P2 of which the resolution is adjusted to P2 of which the resolution is adjusted to ¼, and P3, P4, and P5 of which the resolution sizes are not adjusted, the options for the encoding feature map are increased, whereby the possibility of selecting the best method may be increased.

When the encoding feature map is selected, a resolution adjustment method, which is the method to be used in order to adjust a decoding feature map to have the resolution of the feature map to be reconstructed in the decoding step, may be determined simultaneously therewith.

For example, when settings are made so as to classify an intra-layer resolution adjustment method using a super-resolution technique and an intra-layer resolution adjustment method using an interpolation method as different methods, it may also be determined which of the super-resolution technique and the interpolation method is to be used in order to restore the decoding feature map so as to have the resolution of the feature map to be reconstructed.

### Determination of Encoding Feature Map and Adjustment of Resolution of Encoding Feature Map

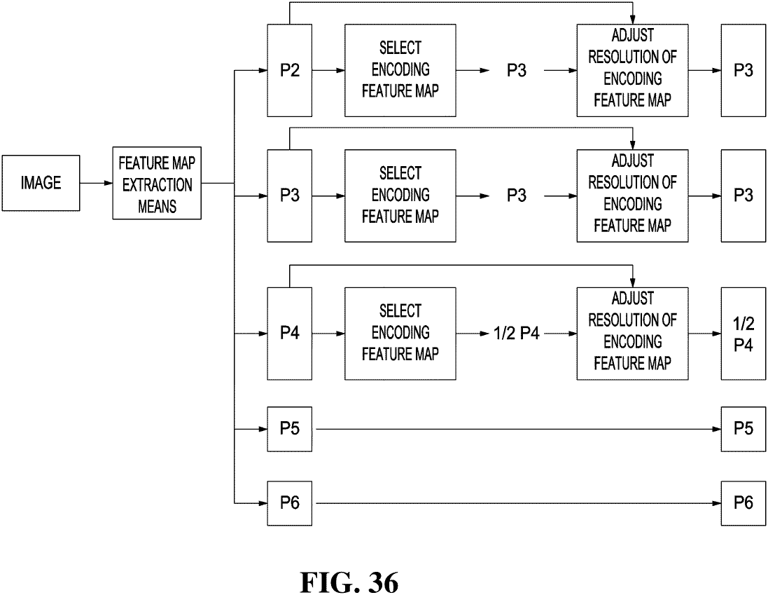

FIG. 36 illustrates a method for determining a different encoding feature map for each layer.

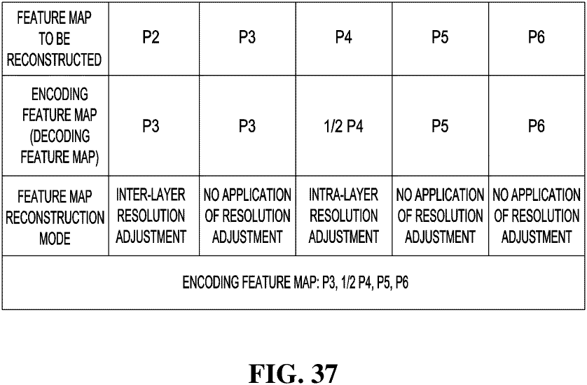

FIG. 37 is a table illustrating that a different encoding feature map and a different feature map reconstruction mode are determined for each layer.

Different encoding feature maps may be determined for respective layers in the same image.

Here, there may be a layer that does not pass through the encoding feature map determination unit 3220. As the encoding feature map for the feature map of such a layer, a feature map that is the same as the original feature map may be used. In FIG. 36, P5 and P6 may not pass through the encoding feature map determination unit 3220.

The decoding apparatus 3300 receives the encoding feature map and information about the feature map to be reconstructed from the encoding apparatus 3200, thereby reconstructing the decoding feature map into the feature map to be reconstructed.

In FIG. 36, the decoding apparatus 3300 may receive information saying that the feature maps to be reconstructed using the decoding feature map P3 are P2 P2 is reconstructed through resolution adjustment using the decoding feature map P3, in which case the feature map reconstruction mode may be inter-layer resolution adjustment. Also, P3 may be reconstructed using the decoding feature map P3 without resolution adjustment, in which case the feature map reconstruction mode may be no application of resolution adjustment. P4, which is the feature map to be reconstructed, may be reconstructed using the decoding feature map ½P4, in which case the feature map reconstruction mode may be intra-layer resolution adjustment. P5 and P6 do not pass through the encoding feature map determination unit 3220, and may be reconstructed using the method of not applying resolution adjustment in the decoding process. Here, P5 and P6 may alternatively pass through the encoding feature map determination unit 3220, but may not pass through the encoding feature map determination unit 3220, as illustrated in FIG. 36.

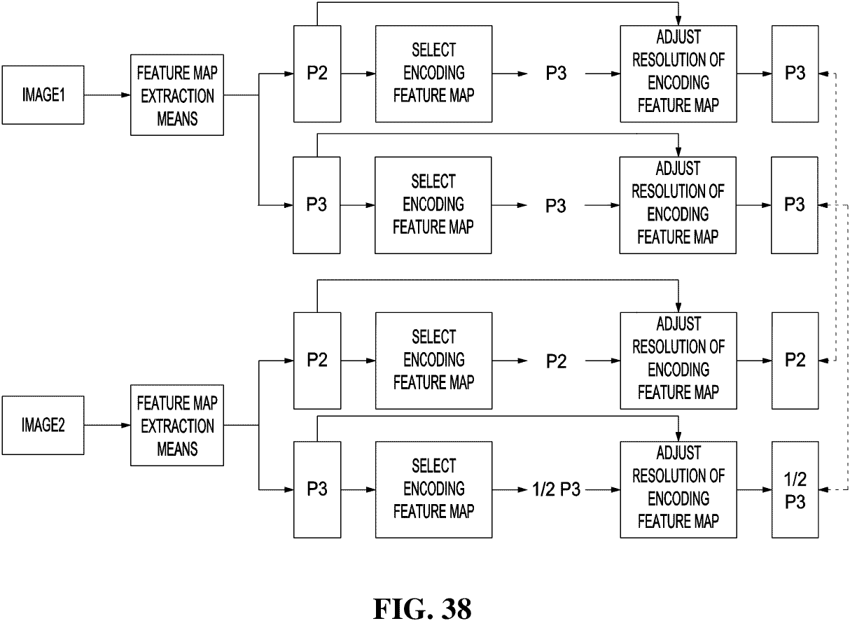

FIG. 38 illustrates a method for determining a different encoding feature map for a feature map of a different layer extracted from a different image.

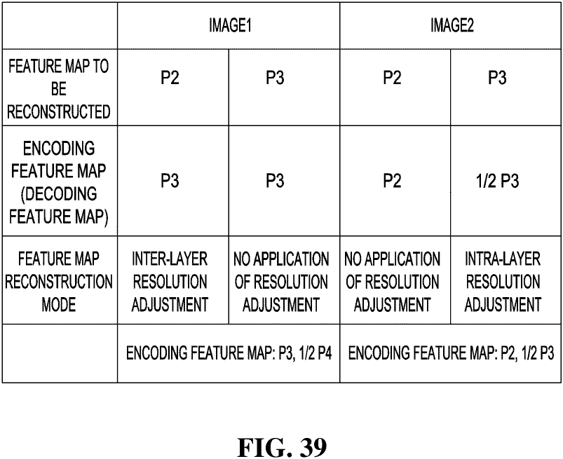

FIG. 39 is a table illustrating that an encoding feature map and a feature map reconstruction mode are determined for a feature map of a different layer extracted from a different image.

Referring to FIG. 38, the encoding feature map determination unit 3220 may determine different encoding feature maps for feature maps of the same layer that are respectively extracted from different images.

In FIG. 38, only P2 and P3 are illustrated, but the encoding feature map determination method may also be applied in the same manner to different layers. Also, a multi-layer feature map is taken as an example, but it may also be applied to a single-layer feature map.

The decoding apparatus 3300 receives the encoding feature map and information about the feature map to be reconstructed from the encoding apparatus 3200, thereby reconstructing the decoding feature map into the feature map to be reconstructed.

Referring to FIG. 38, the decoding apparatus 3300 may receive information saying that the feature maps to be reconstructed using the decoding feature map P3 are P2 and P3 for image 1. Accordingly, P2 may be reconstructed through inter-layer resolution adjustment, and P3 may be reconstructed through no application of resolution adjustment. The decoding apparatus 3300 may receive information saying that the feature map to be reconstructed using the decoding feature map P2 is P2 for image 2. The decoding apparatus 3300 may reconstruct P2 using the method of not applying resolution adjustment, and may reconstruct P3 using an intra-layer resolution adjustment method through information saying that the feature map to be reconstructed through the decoding feature map ½P3 is P3.

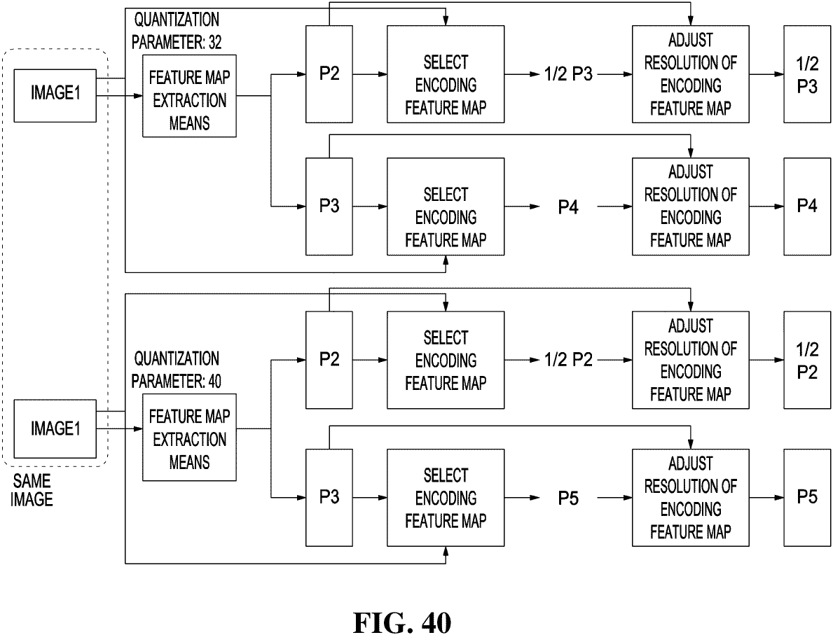

FIG. 40 illustrates a method for determining an encoding feature map when the same image is encoded using different quantization parameters.

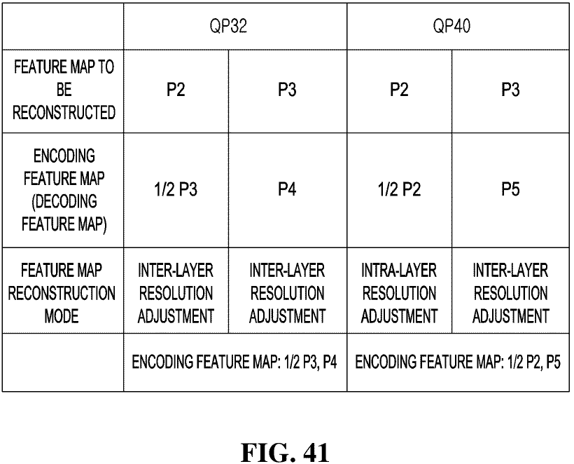

FIG. 41 is a table illustrating that an encoding feature map and a feature map reconstruction mode are determined when the same image is encoded using different quantization parameters.

Referring to FIG. 40, even when a feature map is extracted from the same image, different encoding feature maps may be selected depending on quantization parameters.

Different encoding feature maps may be selected depending on the quantization parameters. As in the example of FIG. 38, the same method may also be applied to a feature map of a different layer or a single-layer feature map.

The decoding apparatus 3300 receives an encoding feature map and information about the feature map to be reconstructed from the encoding apparatus 3200, thereby reconstructing the feature map to be reconstructed using the decoding feature map.

Referring to FIG. 40, when QP32 is used for image 1, the decoder may reconstruct P2 through inter-layer resolution adjustment using the information saying that the feature map to be reconstructed using the decoding feature map ½P3 is P2, and may reconstruct P3, which is the feature map to be reconstructed, using inter-layer resolution adjustment through the decoding feature map P4.

When QP40 is used for image 1, the decoder may reconstruct P2 using an intra-layer resolution adjustment method through the information saying that the feature map to be reconstructed using the decoding feature map ½P2 is P2, and may reconstruct P3 using an inter-layer resolution adjustment method through the information saying that the feature map to be reconstructed through the decoding feature map P5 is P3.

Here, the quantization parameter of the encoding feature map may be determined through the encoding feature map determination unit 3220. Similarly, different quantization parameters may be set depending on the image, the layer of the feature map, or the like.

When the quantization parameter is determined, the output of the encoding feature map determination unit 3220 includes the encoding feature map and the quantization parameter, and the determined information may be transferred to the decoding apparatus 3300.

When the optimal quantization parameter is determined by the encoding feature map determination unit 3220, degradation in machine vision performance may be minimized and the amount of compressed bits may be significantly reduced.

For example, when there is no difference between machine vision performance achieved when the feature map of an image compressed using QP32 is reconstructed and machine vision performance achieved when the feature map of the image compressed using QP40 is reconstructed, it is determined to use QP40 rather than QP 32, whereby the amount of compressed bits may be reduced while maintaining the machine vision performance. Also, different quantization parameters may be selected for respective images (e.g., not QP32 but QP35 may be used for the feature map of another image), and different quantization parameters may be selected for respective layers of the same image (e.g., by using QP35 for P2 and using QP40 for P3).

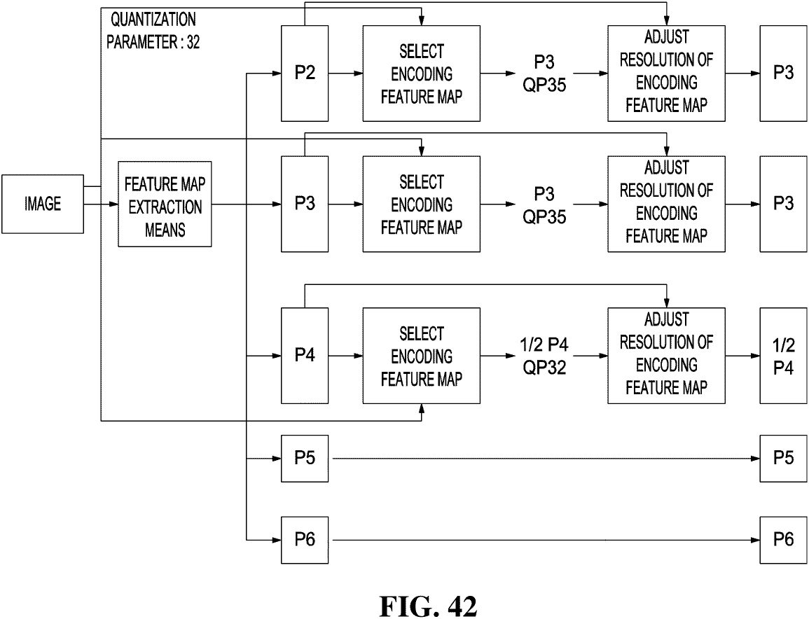

FIG. 42 illustrates a method for determining a quantization parameter in an encoding feature map determination unit.

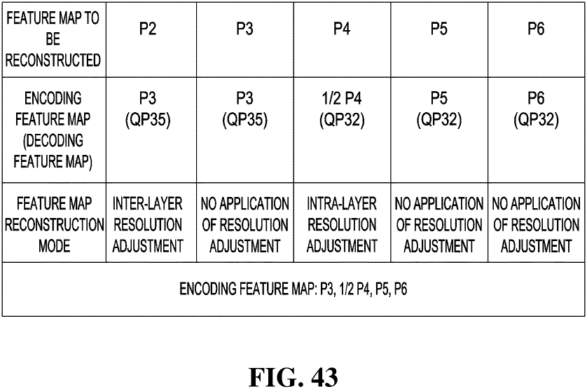

FIG. 43 is a table illustrating that an encoding feature map and a feature map reconstruction mode are determined when an encoding feature map determination unit determines a quantization parameter.

The decoding apparatus 3300 may receive an encoding feature map, information about the feature map to be reconstructed, and changed quantization parameter information from the encoding apparatus 3200 and reconstruct the feature map using the decoding feature map.

Referring to FIG. 42, it can be seen that, although it is intended to compress an image using QP32, the encoding feature map determination unit 3220 selects different optimal quantization parameters for respective layers. The decoding apparatus 3300 receives information saying that the decoding feature map P3 is encoded using QP35, and may reconstruct P2 and P3, which are the feature maps to be reconstructed, respectively using an inter-layer resolution adjustment method and a method of not applying resolution adjustment. Similarly, it can be seen that the decoding feature map ½P4 is compressed using QP32, and P4, which is the feature map to be reconstructed, may be reconstructed using ½P4. In this case, the feature map reconstruction mode may be intra-layer resolution adjustment. Because P5 and P6 do not pass through the encoding feature map determination unit 3220, the first given quantization parameter QP32 may be used therefor.

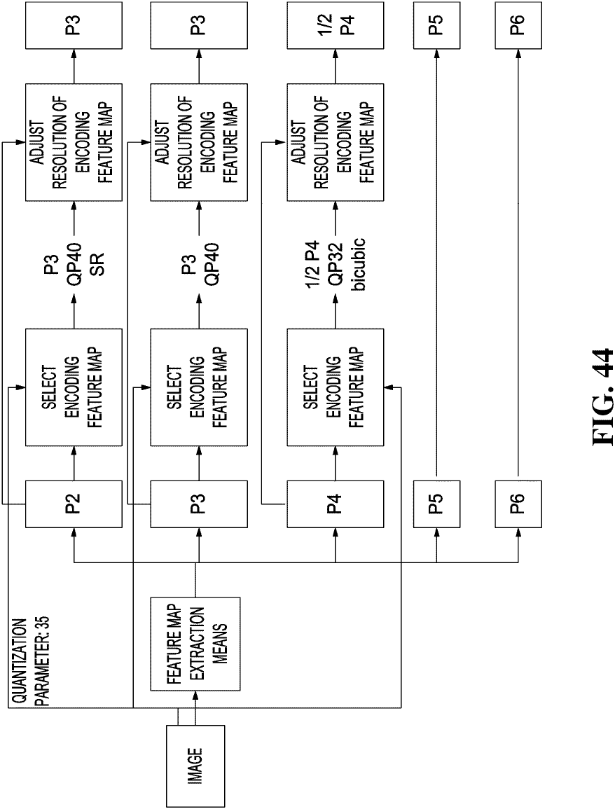

FIG. 44 illustrates that an encoding feature map determination unit determines a resolution adjustment method.

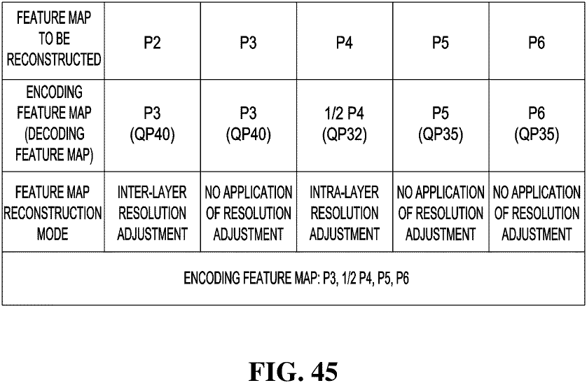

FIG. 45 is a table illustrating that an encoding feature map and a feature map reconstruction mode are determined when an encoding feature map determination unit determines a resolution adjustment method.

Different resolution adjustment methods may be set for respective images or respective layers of a feature map. When the resolution adjustment method is not determined, the same resolution adjustment method may be used for all of the images or all of the layers in the decoding process, and information about only the corresponding method may be transferred to the decoder.

For resolution adjustment, various interpolation methods or a super-resolution method using an artificial neural network may be used.

The encoding feature map determination unit 3220 may determine at least one of an encoding feature map, a quantization parameter, or a resolution adjustment method, or a combination thereof.

FIG. 44 is an example of a method of determining all of the encoding feature map, the quantization parameter, and the resolution adjustment method using the encoding feature map determination unit.

Referring to FIG. 44, the encoding feature map determination unit 3220 may additionally determine a method of adjusting the resolution of the encoding feature map. Here, the resolution adjustment method may use various interpolation methods or an artificial neural network. This may mean the method used for adjustment of the resolution of the encoding feature map, rather than adjustment of the resolution of a decoding feature map.

The decoding apparatus 3300 receives the encoding feature map, the changed quantization parameter, and the resolution adjustment method from the encoding apparatus 3200, thereby reconstructing the decoding feature map into the feature map to be reconstructed.

FIG. 44 is an example in which, although it is intended to compress an image using QP35, the encoding feature map determination unit 3220 selects different optimal quantization parameters for respective layers, and simultaneously, a decoding feature map resolution adjustment method is determined. The decoding apparatus 3300 receives information saying that a decoding feature map P3 is encoded using QP40, thereby reconstruct P2 and P3, which are the feature maps to be reconstructed, respectively using an inter-layer resolution adjustment method and a method of not applying resolution adjustment.

When P2 is reconstructed from the decoding feature map P3, the resolution adjustment method determined by the encoding feature map determination unit 3220 is received, and the resolution may be adjusted using a super-resolution method. Also, it can be seen that the decoding feature map ½P4 is compressed using QP32, and P4, which is the feature map to be reconstructed, may be reconstructed using ½P4. Here, the feature map reconstruction mode is intra-layer resolution adjustment, and bicubic interpolation may be used as a resolution adjustment method.

Because P5 and P6 do not pass through the encoding feature map determination unit 3220, the first given quantization parameter QP35 may be used. Because P3, P5 and P6 are reconstructed using a method of not applying resolution adjustment, the resolution adjustment method is not determined by the encoding feature map determination unit 3220, and the resolution adjustment method may not be transferred to the decoder.

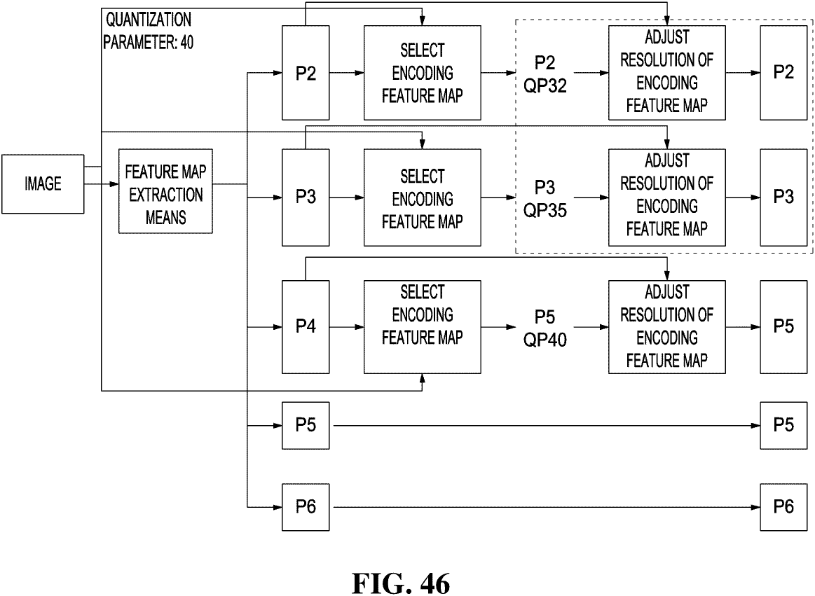

FIG. 46 illustrates a method for determining a quantization parameter by an encoding feature map determination unit.

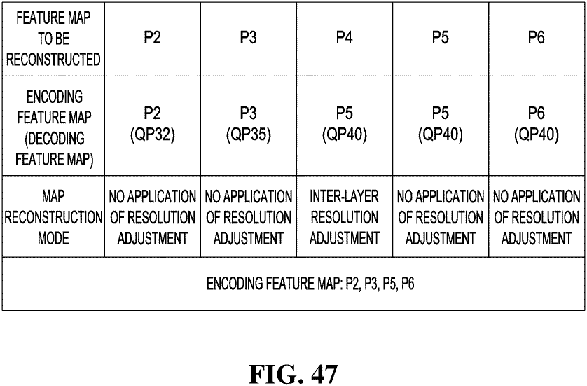

FIG. 47 is a table illustrating that an encoding feature map and a feature map reconstruction mode are determined when an encoding feature map determination unit determines a quantization parameter.

Referring to FIG. 46, a quantization parameter may be set through the encoding feature map determination unit 3220 such that a small-sized object is well detected.

In the case of a multi-layer feature map, a feature map of a low layer plays a large role in detection of small objects. In this case, the detection rate of small objects may be greatly improved using a method of reducing the degree of compression of the feature map of a low layer by decreasing a quantization parameter therefor through the encoding feature map determination unit 3220, a method of not applying resolution adjustment, a method of increasing resolution, or the like.

In the example of FIG. 46, the quantization parameter of P2 is decreased and resolution is not adjusted in order to increase the detection rate of small objects. Also, for a feature map of a high layer, a quantization parameter is increased or an encoding feature map having low resolution is selected, whereby the amount of compressed bits may be reduced.

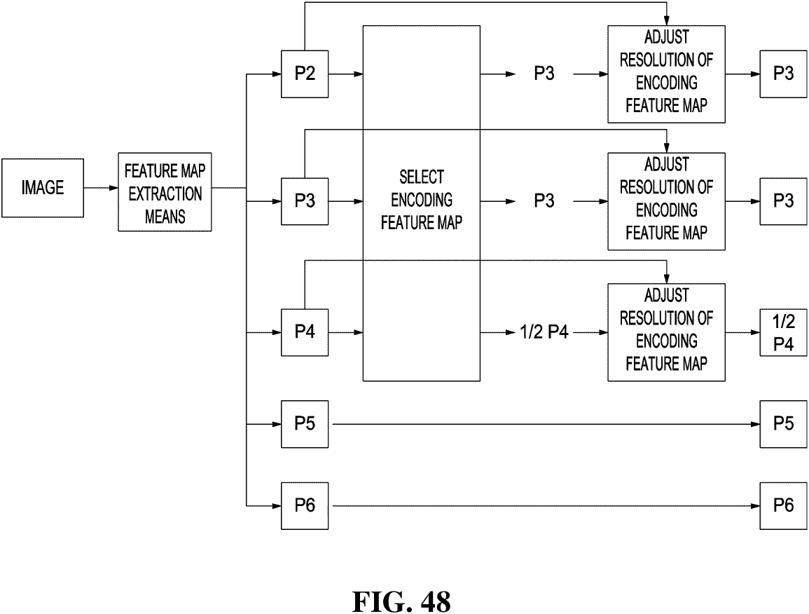

FIG. 48 illustrates the case in which feature maps of multiple layers are input to the encoding feature map determination unit.

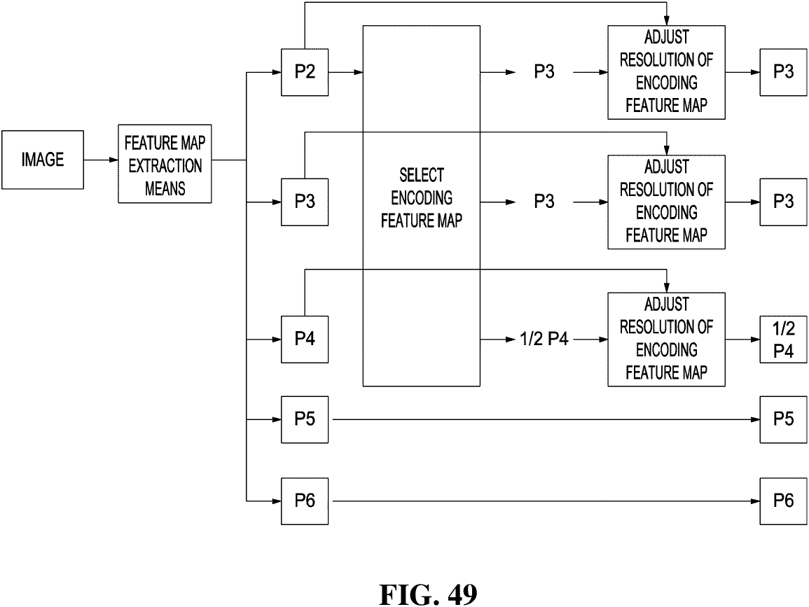

FIG. 49 illustrates the case in which a single feature map is input to the encoding feature map determination unit.

Referring to FIG. 48 and FIG. 49, feature maps of multiple layers may be input to the encoding feature map determination unit 3220.

When only the feature map of a single layer is input to the encoding feature map determination unit 3220, the optimal feature map may be selected for each layer, but a problem may be caused because the encoding feature map determination information of other layers is not considered.

For example, when P3 is selected as the encoding feature map for P2, which is the feature map to be reconstructed, P4 may be selected as the encoding feature map for P3, which is the feature map to be reconstructed. Here, all of the encoding feature maps are P3 and P4, but if P3 is selected as the encoding feature map for P3, which is the feature map to be reconstructed, all of the encoding feature maps include only P3, in which case resolution adjustment is not applied when P3 is reconstructed, so better machine vision performance may be achieved.

In order to consider this, multiple layers may be input to the encoding feature map determination unit 3220, and encoding feature maps for the multiple layers may be output therefrom. Alternatively, only a single layer is input, and encoding feature maps of multiple layers may be output.

FIG. 48 is an example in which the feature maps of multiple layers are input and the encoding feature maps of the multiple layers are output, and FIG. 49 is an example in which the feature map of a single layer is input and encoding feature maps of multiple layers are output.

### Adjustment of Resolution of Decoding Feature Map

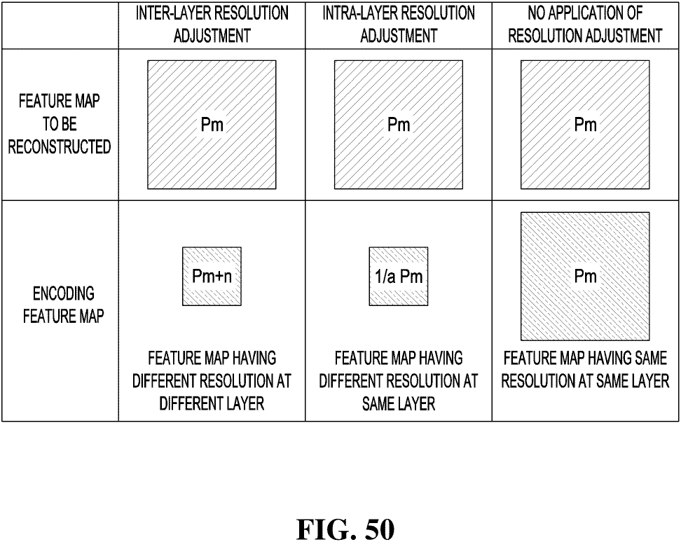

FIG. 50 is a table illustrating an encoding feature map according to a method for reconstructing a feature map of layer m.

Hereinafter, m denotes the layer of the feature map and corresponds to an integer, and n denotes the difference between the layers of feature maps and corresponds to an integer. Also, a is a parameter for adjusting resolution and corresponds to a natural number.

### Inter-Layer Resolution Adjustment

When a feature map, the layer and resolution of which differ from those of the feature map to be reconstructed, is selected as the decoding feature map for the feature map to be reconstructed, the feature map to be reconstructed may be reconstructed through an inter-layer resolution adjustment method in the decoding process. Inter-layer resolution adjustment may be used when the feature map is a multi-layer feature map.

When the inter-layer resolution adjustment method is applied, the feature map of the layer corresponding to the feature map to be reconstructed may not be encoded, whereby a bit amount may be more reduced.

When the inter-layer resolution adjustment method is used by selecting P3 as a decoding feature map for P2, which is the feature map to be reconstructed, there is no need to encode P2, so the amount of compressed bits may be reduced by the resolution of P2.

The higher the layer of the feature map to be used as a decoding feature map for reconstructing a feature map of a low layer, the greater the amount of compressed bits that can be reduced. Also, the amount of compressed bits may be more reduced by decreasing the resolution of the encoding feature map.

For example, either P3 or P4 may be used as the decoding feature map for P2, which is the feature map to be reconstructed, but because the resolution of P4 is less than the resolution of P3 (the width and height of P4 are ½ of the width and ½ of the height of P3), the bit amount may be decreased by about four times.

For example, when ¼P3, the horizontal resolution and the vertical resolution of which are half the horizontal resolution of P3 and half the vertical resolution of P3, is used as a decoding feature map for P2, which is the feature map to be reconstructed, the amount of compressed bits may be reduced more than when P3, the resolution of which is not adjusted, is used.

A single decoding feature map may be selected as a feature map for reconstructing feature maps of multiple layers. Because not all of the feature maps of multiple layers to be reconstructed are required to be encoded, the amount of compressed bits may be more reduced.

For example, when P2 and P3 are selected as the feature maps to be reconstructed using the decoding feature map P4, neither P2 nor P3 is required to be encoded, whereby the amount of compressed bits is significantly reduced.

When the feature map of a high layer is reconstructed, a feature map of a low layer may be used as a decoding feature map. Here, downscaling is used for the decoding feature map, which is used in order to reconstruct the feature map of the high layer, in which case an artificial neural network may be used or an interpolation method having low calculation complexity may be used.

When the artificial neural network is used, the artificial neural network may be trained with feature maps of multiple different layers so as to be applied to adjustment of resolution between the multiple different layers, and the artificial neural network is trained with feature maps for multiple different quantization parameters, whereby a single artificial neural network that works well for various quantization parameters may be made. Alternatively, different artificial neural networks may be used so as to work well in the respective cases.

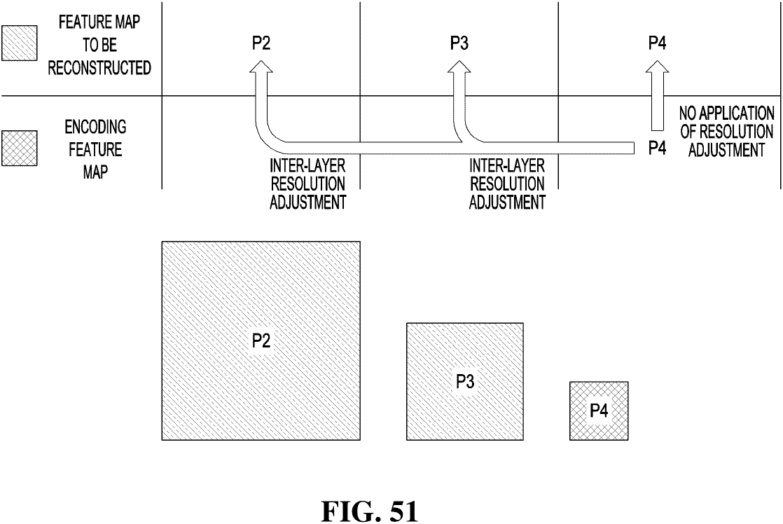

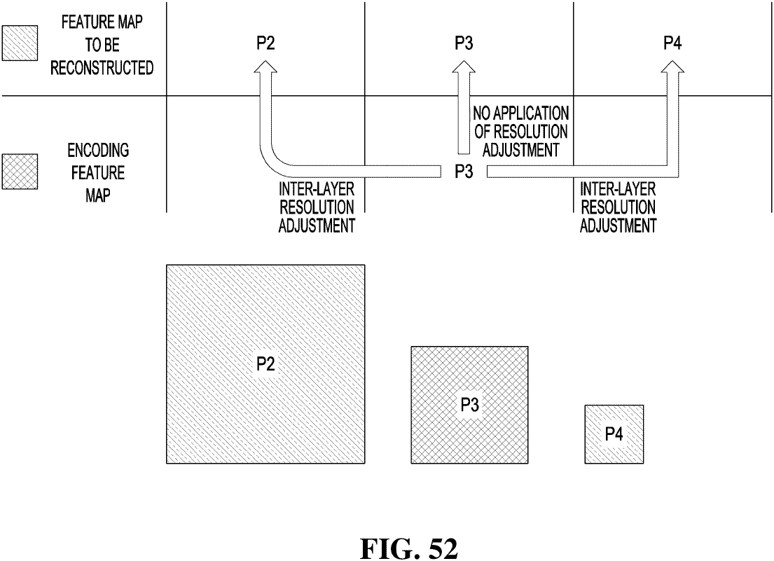

FIG. 51 and FIG. 52 are examples of inter-layer resolution adjustment.

Referring to FIG. 51, when P2 is reconstructed, inter-layer resolution adjustment is used, and m may be 2 and n may be 2 (m = 2, n =2). When P3 is reconstructed, inter-layer resolution adjustment is used, and m may be 3 and n may be 1 (m = 3, n =1). When P4 is reconstructed, resolution adjustment is not used, and m may be 4 (m = 4).

Referring to FIG. 52, when P2 is reconstructed, inter-layer resolution adjustment is used, and m may be 2 and n may be 1 (m = 2, n = 1). When P3 is reconstructed, resolution adjustment is not used, and m may be 3 (m = 3). When P4 is reconstructed, inter-layer resolution adjustment is used, and m may be 4 and n may be -1 (m=4,n=-1).

### Intra-Layer Resolution Adjustment

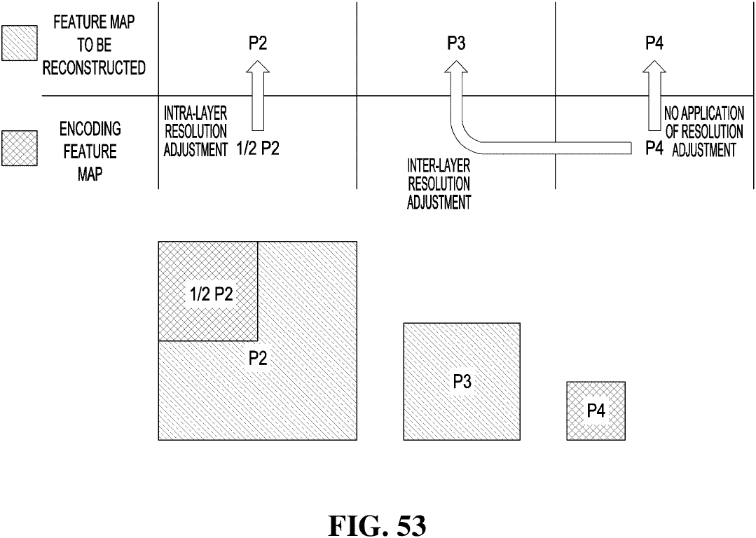

FIG. 53 is an example of intra-layer resolution adjustment.

When a feature map, the resolution of which differs from the resolution of the feature map to be reconstructed, and, the layer of which is the same as the layer of the feature map to be reconstructed, is selected as a decoding feature map for the feature map to be reconstructed, the resolution of the feature map may be restored using an intra-layer resolution adjustment method in the decoding process.

When the intra-layer resolution adjustment method is applied, resolution adjustment may be performed because the resolution of the encoding feature map differs from the resolution of the feature map to be reconstructed.

For example, when P2 having resolution that is lower than the resolution of P2, which is the feature map to be reconstructed, is selected as the encoding feature map, the intra-layer resolution adjustment may be used, in which case the process of lowering the resolution of the encoding feature map may be performed because the resolution of the encoding feature map differs from the resolution of P2, which is the feature map to be reconstructed.

When the encoding feature map is set to have lower resolution, the amount of compressed bits may be more reduced.

FIG. 53 is an example in which an intra-layer resolution adjustment method, an inter-layer resolution adjustment method, and a method of not applying resolution adjustment are used for respective layers. Here, P2, which is the feature map to be reconstructed, may be reconstructed using ½P2, which is a decoding feature map acquired by decreasing the horizontal resolution and vertical resolution of the original feature map to half the horizontal resolution and half the vertical resolution, and P3, which is the feature map to be reconstructed, may be reconstructed using P4. Resolution adjustment may not be applied to the decoding feature map for reconstructing P4.

Referring to FIG. 53, when P2 is reconstructed, intra-layer resolution adjustment is used, and m may be 2 and a may be 2 (m = 2, a =2). When P3 is reconstructed, inter-layer resolution adjustment is used, and m may be 3 and n may be 1 (m =3, n = 1). When P4 is reconstructed, resolution adjustment is not used, and m may be 4 (m = 4).

### Method of Not Applying Resolution Adjustment

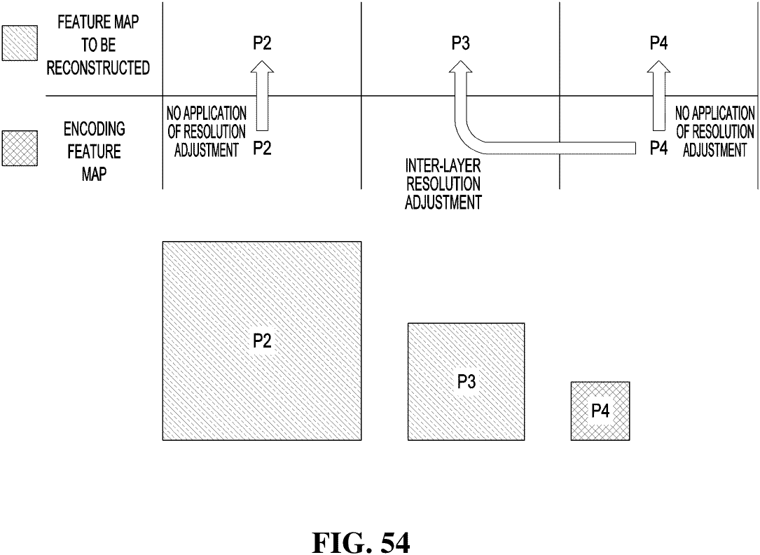

FIG. 54 is an example in which resolution adjustment is not applied to some feature maps.

When a feature map, the layer and resolution of which are the same as those of the feature map to be reconstructed, is selected as a decoding feature map for the feature map to be reconstructed, resolution adjustment may not be applied in the decoding process.

When resolution adjustment is not applied, the amount of compressed bits may not be reduced, but a method of not applying resolution adjustment may be selected in consideration of a bit amount and machine task performance.

For example, in the case of P5 and P6, which are feature maps having low resolution, resolution adjustment may not be applied because the effect of reducing the bit amounts acquired through a resolution adjustment method is small.

Also, in order to detect small objects, the resolution of a decoding feature map of a low layer may not be adjusted, whereby a detection rate may be increased.

Referring to FIG. 54, resolution adjustment is not applied to P2 and P4, and P3 may be reconstructed through inter-layer resolution adjustment using P4, which is the decoding feature map for reconstructing P3, which is the feature map to be reconstructed.

When P2 is reconstructed, resolution adjustment is not used, and m may be 2 (m = 2). When P3 is reconstructed, inter-layer resolution adjustment is used, and m may be 3 and n may be 1 (m = 3, n = 1). When P4 is reconstructed, resolution adjustment is not used, and m may be 4 (m = 4).

### Adjustment of Resolution of Encoding Feature Map

When the resolution of the selected encoding feature map differs from the resolution of the feature map to be reconstructed, the resolution of the encoding feature map is adjusted. In the present disclosure, a method of lowering resolution and a method of not lowering resolution may be used as a method of adjusting the resolution of an encoding feature map.

In the present disclosure, when resolution is lowered, downsampling may be performed using various interpolation methods, or an artificial neural network may be used.

As various interpolation methods, bicubic interpolation, bilinear interpolation, and the like are present, and using a simple method may be advantageous in terms of calculation amounts.

After the resolution of the encoding feature map is adjusted, an encoding and decoding process may be performed on the encoding feature map using an existing image compression codec (e.g., HEVC or VVC) or an artificial neural network compression codec (e.g., end-to-end neural network).

### Arrangement and Rearrangement of Channels of Feature Map

In the encoding and decoding method according to an embodiment of the present disclosure, the following descriptions may be applied with regard to arrangement and rearrangement.

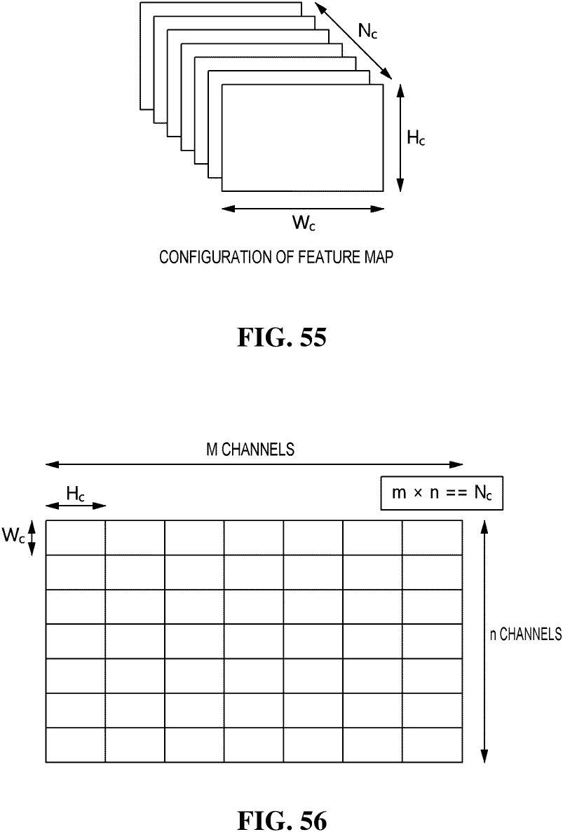

FIG. 55 illustrates the configuration of a feature map according to an example.

A feature map extracted from an artificial neural network is generally configured with multiple channels, as illustrated in FIG. 55.

In FIG. 55, N_{c} may denote the number of channels. Wc may denote the width of the channel. H_{c} may denote the height of the channel.

In order to encode multiple channels, the multiple channels may be transformed into a frame (or a picture), which is an input unit for encoding.

The feature map arranger 1230 may use one of a spatial arrangement method, a temporal arrangement method, and a spatiotemporal arrangement method when it transforms multiple channels into a frame.

The frame of the feature map transformed using such a method may be encoded (or compressed) by the encoding apparatus 1000, and may be decoded (or reconstructed) by the decoding apparatus 1100.

The feature map rearranger 1310 may rearrange the reconstructed frame, which represents the reconstructed feature map, in the original form of the channels.

FIG. 56 illustrates a spatially arranged feature map according to an example.

In FIG. 56, a spatial arrangement method for a feature map is illustrated.

As illustrated in FIG. 56, spatial arrangement may mean that a single feature map frame is configured by arranging the channels of a feature map like tiles by arranging m channels in the horizontal direction and n channels in the vertical direction. Here, m and n may be set such that the multiplication of m and n is equal to the total number of arranged channels, N_{c}.

The frame of the spatially arranged feature map may be encoded using intra-prediction in the encoding apparatus 1000.

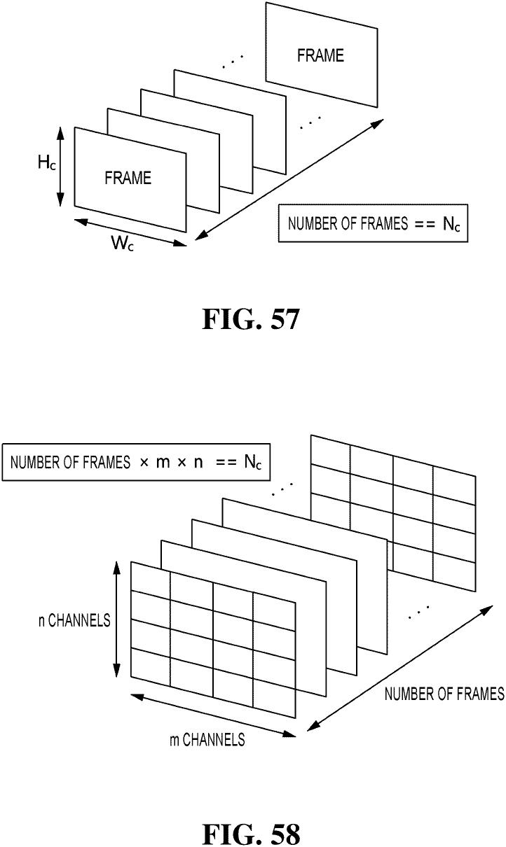

FIG. 57 illustrates a temporally arranged feature map according to an example.

In FIG. 57, a temporal arrangement method for a feature map is illustrated.

As illustrated in FIG. 57, temporal arrangement may mean that the channels of a feature map are temporally arranged such that each of the channels forms a single frame.

With regard to the number of frames, the number of frames for a single feature map may be set equal to the total number of channels N_{c} constituting the feature map.

The frames of the temporally arranged feature map may be encoded using inter-prediction in the encoding apparatus 1000.

In the embodiment, the term ‘inter-prediction’, which is widely used in image coding standards, is used in order to help understanding, but the above-mentioned inter-prediction may be referred to as ‘inter-channel prediction’ in order to distinguish the same from inter-prediction.

FIG. 58 illustrates a feature map arranged in a spatiotemporal manner according to an example.

In FIG. 58, a spatiotemporal arrangement method for a feature map is illustrated.

As illustrated in FIG. 58, spatiotemporal arrangement may be temporal arrangement of spatially arranged frames.

In spatiotemporal arrangement, multiplication of the total number of frames and the number of channels (m × n) constituting a single frame may be set equal to N_{c}, which is the total number of channels to be arranged.

### Feature Map Information

In the encoding and decoding method according to an embodiment of the present disclosure, the following descriptions may be applied with regard to feature map information.

Feature map extraction information may include 1) the size of a channel of a feature map, 2) the number of channels, 3) the number of layers, and 4) information through which the neural network model from which the feature map is extracted can be identified.

Such feature map extraction information needs to be known to the means of performing a machine task, which is performed after decoding in the decoding apparatus 1100, in order to properly perform the task.

Accordingly, the feature map extraction information may be set in advance, and may be encoded by the feature map encoder 1030 so as to generate encoded feature map extraction information. The encoded feature map extraction information may be decoded by the feature map decoder 1110 so as to generate (reconstructed) feature map extraction information. The (reconstructed) feature map extraction information may be transferred to the means of performing a machine task.

For a feature map to which a super-resolution technique is applied, conversion of the feature map and inverse conversion of the (reconstructed) (converted) feature map are performed at steps 1620 and 1720, as described above, and simultaneously, the size of the feature map may be adjusted.

Accordingly, for such adjustment in the feature map encoder 1030 and the feature map decoder 1110, the feature map extraction information may include information about the width of the feature map channel and information about the height of the feature map channel.

Here, the information about the width of the feature map channel may include 1) a scaling factor for downscaling the width of the feature map having original resolution or 2) the width of the downscaled feature map.

Also, the information about the height of the feature map channel may include 1) a scaling factor for downscaling the height of the feature map having original resolution or 2) the height of the downscaled feature map.

The information about the width of the feature map channel and the information about the height of the feature map channel may be transferred to a super-resolution means via the feature map encoding means or the feature map decoding means.

### Feature Map Conversion Information

In the encoding and decoding method according to an embodiment of the present disclosure, the following descriptions may be applied with regard to feature map conversion information.

In order to perform restoration to the original size and shape of a channel by readjusting the size of the channel, parameters used for adjusting the size of the channel of the feature map may be transferred from the encoding apparatus 1000 to the feature map size readjuster 1330.

Here, the parameters used for adjusting the size of the channel of the feature map may include 1) information indicating which of up-sampling and downsampling is used for size adjustment, 2) information indicating which of padding and cropping is used for size adjustment, and 3) information indicating the relationship between the location of the channel before size adjustment and the location of the channel after size adjustment when the size is adjusted using padding or cropping.

The number of bits used for quantization of a feature value, n, and the range of the feature value, Rangeₘₐₓ, may also be transferred from the encoding apparatus 1000 to the feature map dequantizer 1320.

In order to perform restoration to the original channel configuration through rearrangement of channels, parameters used for rearrangement of the channels of the feature map may be transferred from the encoding apparatus 1000 to the feature map rearranger 1310.

Here, the parameters used for rearrangement of the channels of the feature map may include 1) information indicating whether arrangement of the channels of the feature map is spatial arrangement, temporal arrangement, or spatiotemporal arrangement and 2) the number of horizontal channels and the number of vertical channels constituting a single frame when spatial arrangement or spatiotemporal arrangement is used.

Accordingly, the feature map conversion information may be set in advance, and may be encoded by the feature map encoder 1030 so as to generate encoded feature map conversion information. The encoded feature map conversion information may be decoded by the feature map decoder 1110 so as to generate (reconstructed) feature map conversion information. The (reconstructed) feature map conversion information may be transferred to the means of performing a machine task.

For a feature map to which a super-resolution technique is applied, a special parameter or flag indicating whether or not a super-resolution technique is applied to the feature map at steps 1621 and 1722 is required. Here, the parameter or the flag may be included in the above-described parameters related to adjustment of the sizes of one or more channels of the feature map.

When it is determined based on a first specific value of the parameter or flag that a super-resolution technique is applied to the feature map to be processed, 1) the scaling factor for downscaling the width and 2) the scaling factor for downscaling the height may be respectively set as 1) the information about the width of the feature map channel and 2) the information about the height of the feature map channel for the above-mentioned feature map to which the super-resolution technique is applied. Alternatively, when it is determined based on a specific value of the parameter or flag that a super-resolution technique is applied to the feature map to be processed, 1) the width of the downscaled feature map and 2) the height of the downscaled feature map may be respectively set as 1) the information about the width of the feature map channel and 2) the information about the height of the feature map channel for the above-mentioned feature map to which the super-resolution technique is applied.

Like the above-described information about the width of the feature map channel and the above-described information about the height of the feature map channel, the special parameter or flag indicating whether or not a super-resolution technique is applied to the feature map may be transferred to the super-resolution means via the feature map encoding means or the feature map decoding means.

If a super-resolution technique is not applied to the feature map to be processed by setting the parameter or the flag to a second specific value, only the parameter or the flag may be transferred to the super-resolution means via the feature map encoding means or the feature map decoding means, and the information about the width of the feature map channel and the information about the height of the feature map channel may not be transferred.

### Encoding Feature Map and Decoding Feature Map Information

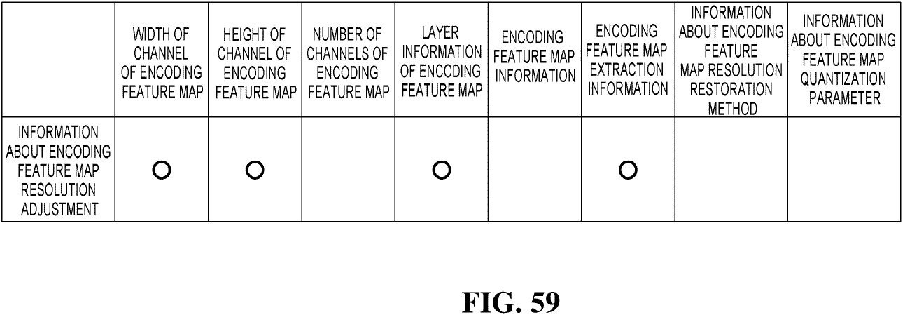

FIG. 59 illustrates information required for deriving encoding feature map resolution adjustment information.

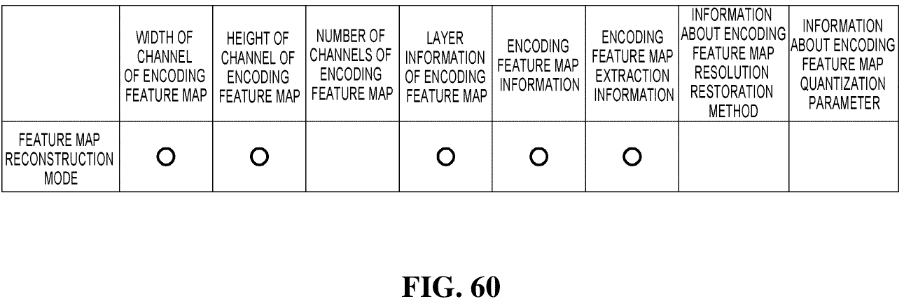

FIG. 60 illustrates information required for deriving a feature map reconstruction mode.

A task may be properly performed only when the means of performing a machine task, which is to be performed in the feature map decoding process and after the feature map decoding process, knows information such as the resolution of an encoding feature map, the number of channels thereof, layer information thereof, the feature map to be reconstructed, feature map extraction information through which the neural network model from which the feature map is extracted can be identified, feature map resolution adjustment information, encoding feature map quantization parameters, a feature map reconstruction mode, and the like.

The resolution of the feature map may mean the horizontal resolution and the vertical resolution of the encoding feature map, and the number of channels of the feature map may mean the number of channels constituting the encoding feature map. The layer information of the feature map may indicate which layer is the encoding feature map.

The feature map to be reconstructed means the feature map to be reconstructed through a decoding feature map, and may indicate the layer information of the feature map to be reconstructed. The feature map to be reconstructed may indicate the layer information and resolution of the feature map to be reconstructed according to need.

The feature map extraction information indicates the neural network model from which the feature map is extracted, and may indicate the number of layers of the feature map, the resolution of the feature map of each layer, and the like. Using the feature map extraction information, other pieces of information may be simplified. For example, in the case of a multi-layer feature map extracted through a feature pyramid model (FPN), the number of channels is identical in all layers, so there is no need to transfer the number of channels of the encoding feature map.

The feature map resolution adjustment method is determined by the encoding feature map determination unit 3220, and may indicate information about the method to be used for adjusting the resolution of a decoding feature map. A super-resolution method or an interpolation method such as bicubic interpolation may be used. When the resolution adjustment method is not determined by the encoding feature map determination unit 3220, the method may be set in advance without the need to send the information each time, so the information may not be used or may be sent only once at first.

The feature map quantization parameter information indicates, when a quantization parameter is changed by the encoding feature map determination unit 3220, the changed quantization parameter.

The feature map reconstruction mode is information about the mode that is to be used when a decoding feature map is reconstructed into the feature map to be reconstructed. It may include inter-layer resolution information, intra-layer resolution information, and non-adjustment of resolution.

It is desirable that these pieces of information are set in advance or transferred to the means of performing a machine task after being encoded by the feature map encoding unit 3250 and decoded by the means of decoding the feature map. Among these pieces of information, the information determined by the encoding feature map determination unit 3220, such as the resolution of the encoding feature map, the feature map to be reconstructed, the information about the decoding feature map resolution adjustment method, and the encoding feature map quantization parameter information, has to be announced to the decoding apparatus 3300.

The information about the encoding feature map selected by the encoding feature map determination unit 3220 may be separately transferred using a flag value, and the corresponding information may be acquired using the resolution of the encoding feature map, the layer information thereof, and the information about the feature map to be reconstructed.

The information about adjustment of the resolution of the encoding feature map of a corresponding layer may be acquired through the encoding feature map resolution, the layer information thereof, and the extraction information. Alternatively, the information about adjustment of the resolution of the encoding feature map may be transferred using an additional flag value. Alternatively, the information may be set using a scale factor value indicating the degree of adjustment of the resolution of the encoding feature map, or the value may not be transferred when resolution adjustment is not applied.

For example, referring to FIG. 59, the resolution of the original feature map of a corresponding layer may be acquired through the encoding feature map extraction information and the layer information. When the encoding feature map is extracted from a feature pyramid network and the original resolution of P4 is 10 × 10, if the layer information of the encoding feature map is P4 and each of the horizontal resolution and the vertical resolution of the encoding feature map is 5, it can be seen that the horizontal resolution and the vertical resolution of the corresponding feature map are respectively reduced by half the horizontal resolution and half the vertical resolution.

Alternatively, when each of the horizontal resolution and the vertical resolution of the encoding feature map is set to ½, the resolution adjustment information may be acquired, and it can be seen that the original resolution of P4 is 10 × 10 through the encoding feature map extraction information and the layer information. Accordingly, it can be seen that each of the width and height of the channel of the encoding feature map is 5.

A feature map reconstruction mode may be derived from information about the resolution of the encoding feature map, layer information of the encoding feature map, information about the feature map to be reconstructed, and encoding feature map extraction information, or the feature map reconstruction mode information may be transferred.

When the layer of the encoding feature map differs from the layer of the feature map to be reconstructed, it can be seen that inter-layer resolution adjustment is applied to the feature map of the corresponding layer. For example, when the layer of the encoding feature map is P4 and when the layer of the feature map to be reconstructed is P2, it can be seen that inter-layer resolution adjustment is applied to the corresponding feature map.

When the layer of the encoding feature map is the same as the layer of the feature map to be reconstructed and when the resolution of the encoding feature map differs from the resolution of the feature map to be reconstructed, it can be seen that intra-layer resolution adjustment is applied to the feature map of the corresponding layer. For example, when both the layer of the encoding feature map and the layer of the feature map to be reconstructed are P3 and when the resolution of the encoding feature map differs from the resolution of the feature map to be reconstructed, it can be seen that intra-layer resolution adjustment is applied to the corresponding feature map. The resolution information of the feature map to be reconstructed may be acquired through the feature map extraction information.

When the layer and resolution of the encoding feature map are the same as those of the feature map to be reconstructed, it can be seen that resolution adjustment is not applied in the decoding process.

### Quantization and Dequantization of Feature Value

In the encoding and decoding method according to an embodiment of the present disclosure, the following descriptions may be applied with regard to size adjustment.

Uniform quantization or non-uniform quantization may be used for quantization of the value of a feature, and the feature value may be quantized to an n-bit integer.

Equation (3) below may show the process of n-bit uniform quantization of a feature value.

$$\begin{matrix}{F}_{C o n v e r t e d} = R o u n d \left(\left({F}_{O r i g i n a l}\right) \times \left({2}^{n} - 1\right) / R a n g {e}_{m a x}\right) \\ + {2}^{n - 1}\end{matrix}$$

$$I F , {F}_{C o n v e r t e d} > {2}^{n - 1} , {F}_{C o n v e r t e d} = {2}^{n - 1}$$

$${F}_{C o n v e r t e d} < 0 , {F}_{C o n v e r t e d} = 0 \qquad \text{(3)}$$

Equation (4) below may show the process of uniform dequantization of F_{original}, which is the feature value restored after quantization.

$$\hat{F} = \left(\left({\tilde{F}}_{C o n v e r t e d} - {2}^{n - 1}\right) / \left({2}^{n} - 1\right)\right) \times R a n g {e}_{m a x} \qquad \text{(4)}$$

In quantization, rounding may be applied in order to reduce an error in the process of making a value an integer, as shown in Equation (3), and a process of clipping values falling out of the range of an n-bit integer may be included.

In order to perform quantization and dequantization, the value of n, which is the number of bits of the quantization result, and Rangeₘₐₓ, which is the range of the feature value, have to be set.

The value of n may be set to a value capable of being input to a general image encoding apparatus, such as 8 or 10, and may also be set to a smaller value, such as 4 or 6, in order to improve compression performance.

The value of Rangeₘₐₓ may be the difference between the maximum value and the minimum value of the feature values to be encoded, or may be a predefined value.

The value of n and the value of Rangeₘₐₓ are parameters related to quantization of a feature value, and values same as the values used in the encoding apparatus 1000 have to be used in the decoding apparatus 1100. Accordingly, the value of n and the value of Rangeₘₐₓ may be predefined in the encoding apparatus 1000 and the decoding apparatus 1100. Alternatively, the value of n and the value of Rangeₘₐₓ may be included in a bitstream or a computer-readable recording medium through the feature map encoder 1030, and may be transferred to the feature map decoder 1110 of the decoding apparatus 1100 through the bitstream or the computer-readable recording medium.

Quantization of the feature value may be performed before or after the size of the feature map is adjusted. In order to reduce calculation complexity, quantization may be performed before size adjustment. In order to reduce a calculation error in the size adjustment process, quantization may be performed after size adjustment.

Dequantization of the feature value may also be performed before or after the size of the feature map is readjusted. In order to reduce calculation complexity, dequantization may be performed before size readjustment. In order to reduce a calculation error in the size readjustment process, dequantization may be performed after size readjustment.

### Determination of Decoding Feature Map on Which Resolution Adjustment is to be Performed

Decoding feature maps may be feature maps on which resolution adjustment has to be performed or feature maps on which resolution adjustment is not required to be performed.

A decoder may determine a decoding feature map or the channel(s) of the feature map for which resolution adjustment is to be performed using the information received from an encoder.

That is, whether to perform resolution adjustment or not may be determined using a feature map reconstruction mode, which is received from the encoding apparatus 3200 or derived from the information received from the encoding apparatus 3200.

When the feature map reconstruction mode is an ‘inter-layer resolution adjustment method’ or an ‘intra-layer resolution adjustment method’, resolution adjustment may be performed on the corresponding decoding feature map or the channel(s) of the feature map.

When the feature map reconstruction mode is ‘no application of resolution adjustment’, resolution adjustment is not performed on the corresponding feature map or the channel(s) of the feature map.

### Method for Reducing Redundancy Between Channels

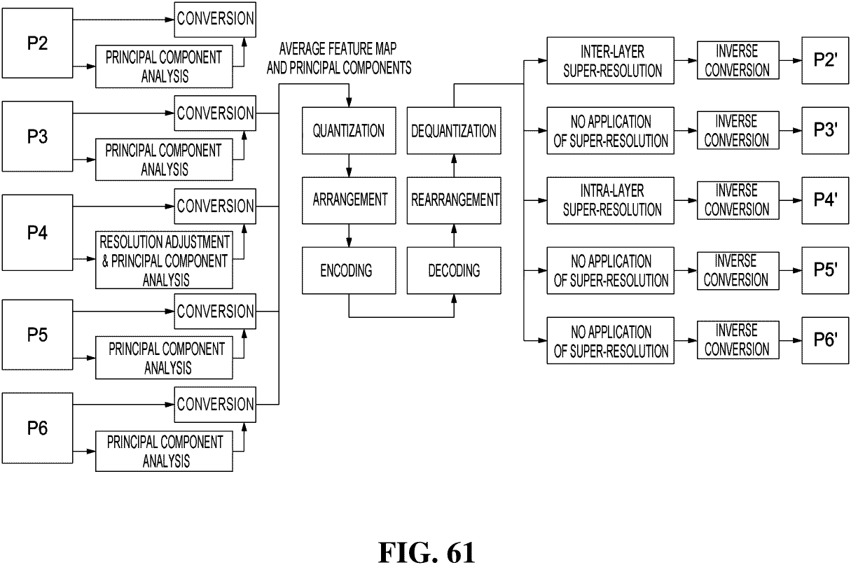

FIG. 61 illustrates an encoding and decoding method according to an embodiment of the present disclosure.

The present disclosure relates to a method for reducing spatial redundancy of a multi-layer feature map using inter-layer resolution adjustment. Here, if the redundancy between the channels of the feature map is also reduced, higher compression efficiency may be achieved.

In order to reduce redundancy between channels, principal component analysis (PCA), independent component analysis (ICA), nonlinear PCA, or an artificial neural network may be used.

FIG. 61 is an example of a method of encoding and decoding the average feature map and principal components, which are acquired through PCA for each layer, using an inter-channel resolution adjustment method, an intra-channel resolution adjustment method, and a method of not applying resolution adjustment. Through this, both the spatial redundancy of the multi-layer feature map and redundancy between the channels may be reduced. Here, all of the transform coefficients generated through transformation of PCA may be separately compressed.

An example of inter-layer resolution adjustment is P2. In the case of P2, only transform coefficients are acquired through PCA and transformation, and the average feature map and the principal components are not encoded. After the average feature map and principal components acquired through PCA of P3 are encoded and decoded, the resolution sizes thereof are made to match the resolution sizes of the average feature map and principal components of P2 through the inter-layer resolution adjustment method, and then the decoded P2 may be inversely converted.

An example of intra-layer resolution adjustment is P4. In the case of P4, after the average feature map and principal components acquired through resolution adjustment and PCA are decoded, the original resolution may be restored through intra-layer resolution adjustment and used for inverse conversion. Here, the resolution adjustment and the PCA may be applied in any order.

Examples of no application of resolution adjustment are P3, P5, and P6. The average feature map and principal components acquired from each layer through PCA are encoded without resolution adjustment, and may be used for inverse conversion without change after being decoded.

The above-described embodiments may be performed using the same method and/or corresponding methods in the encoding apparatus 3200 and the decoding apparatus 3300. Also, a combination of one or more of the above-described embodiments may be used for encoding and/or decoding.

The order in which the above-described embodiments are applied in the encoding apparatus 3200 may differ from that in the decoding apparatus 3300. Alternatively, the order in which the above-described embodiments are applied in the encoding apparatus 3200 and that in the decoding apparatus 3300 may be (at least partially) the same as each other.

The above-described embodiments may be performed separately on each of a luma signal and a chroma signal. The above-described embodiments may be equally performed on the luma signal and the chroma signal.

A block to which the above-described embodiments are applied may have a square shape or a non-square shape.

In the above-described embodiments, it may be construed that, when specified processing is applied to a specified target, specified conditions may be required. Also, it may be construed that, when a description is made such that the specified processing is performed under a specified decision, whether the specified conditions are satisfied may be determined based on a specified coding parameter and that, alternatively, when a description is made such that a specified decision is made based on a specified coding parameter, the specified coding parameter may be replaced with an additional coding parameter. In other words, it may be considered that a coding parameter that influences the specified condition or the specified decision is merely exemplary, and it may be understood that, in addition to the specified coding parameter, a combination of one or more other coding parameters may function as the specified coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the present disclosure.

The above-described embodiments include various aspects of examples. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments according to the present disclosure may be implemented as program instructions that can be executed by various computer components and may be recorded on a computer-readable recording medium. The computer-readable recording medium may include program instructions, data files, and data structures, either solely or in combination. Program instructions recorded on the computer-readable recording medium may have been specially designed and configured for the present disclosure, or may be known to or available to those who have ordinary knowledge in the field of computer software.

The computer-readable recording medium may include information used in embodiments according to the present disclosure. For example, the computer-readable recording medium may include a bitstream, and the bitstream may include information described in the embodiments of the present disclosure.

The computer-readable recording medium may include a non-transitory computer-readable medium.

Examples of the computer-readable recording medium include hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

There are provided an apparatus, method, and recording medium for reducing degradation in performance of a task while reducing the amount of compressed bits of a feature map by providing a method for converting the resolution of the feature map extracted through an artificial neural network and a method for encoding the feature map.

There are provided an apparatus, method, and recording medium for improving feature-map encoding performance by aligning the size of a feature map channel with a block size of a means of encoding a feature map.

There are provided an apparatus, method, and recording medium that use a super-resolution technique as a method for converting the resolution of a feature map.

There are provided an apparatus, method, and recording medium that use a result generated by applying compression and reconstruction to a feature map as training data.

There are provided an apparatus, method, and recording medium for improving resolution while reducing compression artifacts of a feature map by learning super-resolution using training data.

There are provided an apparatus, method, and recording medium for decreasing the resolution of a feature map channel and applying super-resolution to a reconstructed image, which is generated by compressing and adjusting the feature map adjusted to have lower resolution.

There are provided an apparatus, method, and recording medium for improving encoding performance by performing compression and reconstruction using some of multiple feature maps.

As described above, although the present disclosure has been described based on specific details such as detailed components and a limited number of embodiments and drawings, the embodiments are merely provided for easy understanding of the entire disclosure, the present disclosure is not limited thereto, and those skilled in the art will practice various changes and modifications from the above description.

Accordingly, it should be noted that the spirit of the present disclosure is not limited to the above-described embodiments, and the accompanying claims and equivalents and modifications thereof fall within the scope of the present disclosure.

What is claimed is:

1. An encoding method, comprising:
extracting a feature map from an input image;
determining an encoding feature map based on the extracted feature map;
generating a converted feature map by performing conversion on the encoding feature map; and
performing encoding on the converted feature map.

2. The encoding method of claim 1, wherein the encoding feature map corresponds to at least any one of multi-layer feature maps extracted from the input image.

3. The encoding method of claim 1, wherein generating the converted feature map includes adjusting resolution of the encoding feature map.

4. The encoding method of claim 2, wherein the encoding feature map corresponds to any one of a feature map, a layer and resolution of which differ from a layer and resolution of a feature map to be reconstructed, a feature map, a layer of which is identical to the layer of the feature map to be reconstructed, and, resolution of which differs from the resolution of the feature map to be reconstructed, and a feature map, a layer and resolution of which are identical to the layer and resolution of the feature map to be reconstructed.

5. The encoding method of claim 4, wherein:
performing the encoding comprises performing encoding on the converted feature map and metadata on the converted feature map, and
the metadata includes information about the feature map to be reconstructed based on the encoding feature map.

6. The encoding method of claim 5, wherein, when resolution of the encoding feature map is adjusted, the metadata further includes information about a size of the encoding feature map.

7. The encoding method of claim 1, wherein determining the encoding feature map comprises determining the encoding feature map differently depending on a quantization parameter of the extracted feature map.

8. The encoding method of claim 5, wherein:
the metadata includes information about a feature map reconstruction mode, and
the feature map reconstruction mode corresponds to any one of an inter-layer resolution adjustment mode, an intra-layer resolution adjustment mode, and a resolution non-adjustment mode.

9. A decoding method, comprising:
reconstructing a converted feature map by performing decoding on information about an encoded feature map; and
generating a reconstructed feature map by performing inverse conversion on the reconstructed converted feature map.

10. The decoding method of claim 9, wherein the encoded feature map corresponds to any one of multi-layer feature maps extracted from an input image or a feature map, resolution of which is adjusted.

11. The decoding method of claim 9, wherein generating the reconstructed feature map comprises adjusting resolution of the reconstructed feature map.

12. The decoding method of claim 10, wherein the encoded feature map corresponds to any one of a feature map, a layer and resolution of which differ from a layer and resolution of a feature map to be reconstructed, a feature map, a layer of which is identical to the layer of the feature map to be reconstructed, and, resolution of which differs from the resolution of the feature map to be reconstructed, and a feature map, a layer and resolution of which are identical to the layer and resolution of the feature map to be reconstructed.

13. The decoding method of claim 12, wherein:
reconstructing the converted feature map comprises performing decoding on the encoded feature map and metadata on the encoded feature map, and
the metadata includes information about the feature map to be reconstructed based on the encoded feature map.

14. The decoding method of claim 13, wherein, when resolution of the encoded feature map is adjusted, the metadata further includes information about a size of the encoded feature map.

15. The decoding method of claim 13, wherein:
the metadata includes information about a feature map reconstruction mode, and
the feature map reconstruction mode corresponds to any one of an inter-layer resolution adjustment mode, an intra-layer resolution adjustment mode, and a resolution non-adjustment mode.

16. A computer-readable recording medium for storing a bitstream for image decoding, the bitstream comprising:
encoded feature map information and metadata, wherein:
decoding of a hierarchical feature map is performed using the encoded feature map information and metadata.
